(19) United States
(12) Patent Application Publication
(10) Pub. No.: US 2025/0081224 A1
(43) Pub. Date: Mar. 6, 2025

(54) WIRELESS BASE STATION, CONTROL DEVICE, AND CONTROL METHOD

(71) Applicant: NEC Corporation, Minato-ku, Tokyo (JP)

(72) Inventors: Toshiki TAKEUCHI, Tokyo (JP); Kazushi MURAOKA, Tokyo (JP); Yasushi MARUTA, Tokyo (JP)

(73) Assignee: NEC Corporation, Minato-ku, Tokyo (JP)

(21) Appl. No.: 18/574,798

(22) PCT Filed: Dec. 10, 2021
(86) PCT No.: PCT/JP2021/045467

§ 371 Date: Dec. 28, 2023

(30) Foreign Application Priority Data
Jul. 2, 2021 (JP) 2021-110480

(51) Int. Cl. H04W 72/541; H04W 24/02

(52) U.S. Cl. CPC H04W 72/541; H04W 24/02

(57) ABSTRACT

A wireless base station includes an interference-sensing means for sensing the occurrence of interference at the wireless base station, an interference analysis means for executing analysis that is based on the result of sensing by the interference-sensing means and that includes estimation as to the continuity of the interference, and a wireless resource control means for executing wireless resource control for reducing the effect of the interference in accordance with the result of analysis by the interference analysis means. The continuity includes temporal continuity and/or spatial continuity.

### TECHNICAL FIELD

The present invention relates to a wireless communication system and the like.

### BACKGROUND ART

In a wireless communication system, there is a case in which communication performance deteriorates due to occurrence of radio wave interference caused by an adjacent different wireless communication system. For example, in some cases, a system throughput is reduced, or a throughput of each wireless terminal is reduced. Meanwhile, a technique of executing control for reducing influence of such radio wave interference is known (e.g., refer to PTL 1).

In the technique described in PTL 1, a waveform feature value based on a received signal in a first wireless communication system is extracted. Next, it is determined whether the extracted waveform feature value is similar to a predetermined waveform feature value. According to a result of the determination, an interference notification signal is transmitted to a second wireless communication system, and communication parameters (transmission power, antenna directivity, and the like) of the second wireless communication system are controlled. This reduces influence of interference with the first wireless communication system being caused by the second wireless communication system.

As a related technique, a technique described in PTL 2 is also known. Further, as related techniques, techniques described in PTLs 3 to 6 are also known.

### CITATION LIST

### Patent Literature

PTL 1: Japanese Unexamined Patent Application Publication No. 2012-175195
PTL 2: Japanese Unexamined Patent Application Publication No. 2019-071628
PTL 3: Japanese Unexamined Patent Application Publication No. H08-163630
PTL 4: Japanese Unexamined Patent Application Publication No. H08-195977
PTL 5: Japanese Unexamined Patent Application Publication No. 2001-145155
PTL 6: Japanese Unexamined Patent Application Publication No. 2014-175784

### SUMMARY OF INVENTION

### Technical Problem

In the technique described in PTL 1, when controlling the communication parameters of the second wireless communication system, temporal consecutiveness of radio wave interference, temporal continuity of radio wave interference, temporal periodicity of radio wave interference, and the like are not taken into account. Further, spatial consecutiveness of radio wave interference and a spatial spread of radio wave interference are also not taken into account. Thus, there is a problem that such control may be executed unnecessarily. For example, when radio wave interference occurs instantaneously (i.e., in a pinpoint manner) at a specific spot and at a specific time, there is a high probability that control of the communication parameters in response to such radio wave interference is unnecessary. There is a problem that such control may be executed even in such a case.

In view of the above-described problem, in a case of executing control for reducing influence of radio wave interference in a wireless communication system, an object of the present invention is to suppress unnecessary execution of such control.

### Solution to Problem

Hereinafter, at least one of temporal consecutiveness of radio wave interference, temporal continuity of radio wave interference, and temporal periodicity of radio wave interference is collectively referred to as “temporal consecutiveness” in some cases. At least one of spatial consecutiveness of radio wave interference and a spatial spread of radio wave interference is collectively referred to as “spatial consecutiveness” in some cases. At least one of the temporal consecutiveness and the spatial consecutiveness is collectively referred to simply as “consecutiveness” in some cases.

In one aspect of the present invention, a wireless communication system is a wireless communication system including one or more wireless base stations, and includes: an interference detection means for detecting occurrence of interference in the wireless communication system; an interference analysis means for executing analysis that is based on a result of detection by the interference detection means and includes estimation of consecutiveness of the interference; and a wireless resource control means for, according to a result of analysis by the interference analysis means, executing wireless resource control for reducing influence of the interference, in which the consecutiveness includes at least one of temporal consecutiveness and spatial consecutiveness.

In another aspect of the present invention, a control device is a control device for a wireless communication system including one or more wireless base stations, and includes: an interference detection means for detecting occurrence of interference in the wireless communication system; an interference analysis means for executing analysis that is based on a result of detection by the interference detection means and includes estimation of consecutiveness of the interference; and a wireless resource control means for, according to a result of analysis by the interference analysis means, executing wireless resource control for reducing influence of the interference, in which the consecutiveness includes at least one of temporal consecutiveness and spatial consecutiveness.

In another aspect of the present invention, a control method is a control method for a wireless communication system including one or more wireless base stations, and includes: detecting, by an interference detection means, occurrence of interference in the wireless communication system; executing, by an interference analysis means, analysis that is based on a result of detection by the interference detection means and includes estimation of consecutiveness of the interference; and executing, by a wireless resource control means, according to a result of analysis by the interference analysis means, wireless resource control for reducing influence of the interference, in which the consecutiveness includes at least one of temporal consecutiveness and spatial consecutiveness.

In another aspect of the present invention, a program is a program for causing a computer for a wireless communication system including one or more wireless base stations to function as: an interference detection means for detecting occurrence of interference in the wireless communication system; an interference analysis means for executing analysis that is based on a result of detection by the interference detection means and includes estimation of consecutiveness of the interference; and a wireless resource control means for, according to a result of analysis by the interference analysis means, executing wireless resource control for reducing influence of the interference, in which the consecutiveness includes at least one of temporal consecutiveness and spatial consecutiveness.

### Advantageous Effects of Invention

According to the present invention, in a case of executing control for reducing influence of radio wave interference in a wireless communication system, unnecessary execution of such control can be suppressed.

### BRIEF DESCRIPTION OF DRAWINGS

FIG. 1 is an illustration illustrating a main part of a wireless communication system according to a first example embodiment.

FIG. 2 is a block diagram illustrating a main part of a wireless base station according to the first example embodiment.

FIG. 3 is a block diagram illustrating a hardware configuration of a main part of a base station device according to the first example embodiment.

FIG. 4 is a block diagram illustrating another hardware configuration of the main part of the base station device according to the first example embodiment.

FIG. 5 is a block diagram illustrating another hardware configuration of the main part of the base station device according to the first example embodiment.

FIG. 6 is a flowchart illustrating operation of the main part of the base station device according to the first example embodiment.

FIG. 7A is an illustration illustrating an example of time slots in quasi-synchronous TDD of a 4.7-GHz band.

FIG. 7B is an illustration illustrating an example of time slots in quasi-synchronous TDD of a 28-GHz band.

FIG. 8 is a block diagram illustrating an example of a main part of an interference analysis unit in the base station device according to the first example embodiment.

FIG. 9A is an illustration illustrating an example of processing of estimating spatial consecutiveness, and is the illustration illustrating an example of a case in which a position and a direction of an interference source are not taken into account.

FIG. 9B is an illustration illustrating an example of processing of estimating spatial consecutiveness, and is the illustration illustrating an example of a case in which a position and a direction of an interference source are taken into account.

FIG. 10 is a block diagram illustrating an example of a main part of a wireless resource control unit in the base station device according to the first example embodiment.

FIG. 11 is a block diagram illustrating a main part of another wireless base station according to the first example embodiment.

FIG. 12 is an illustration illustrating an example of an image including interference analysis information and wireless resource control information.

FIG. 13A is an illustration illustrating a main part of a control device according to the first example embodiment.

FIG. 13B is an illustration illustrating a main part of another control device according to the first example embodiment.

FIG. 14 is an illustration illustrating a main part of a wireless communication system according to a second example embodiment.

FIG. 15 is a block diagram illustrating a main part of a wireless base station according to the second example embodiment.

FIG. 16 is a flowchart illustrating operation of a main part of a base station device according to the second example embodiment.

FIG. 17 is a block diagram illustrating a main part of a control device according to the second example embodiment.

FIG. 18 is an illustration illustrating a main part of a wireless communication system according to a third example embodiment.

FIG. 19 is a block diagram illustrating a main part of a wireless base station according to the third example embodiment.

FIG. 20 is a flowchart illustrating operation of a main part of a base station device according to the third example embodiment.

FIG. 21 is a block diagram illustrating a main part of another wireless base station according to the third example embodiment.

FIG. 22 is a block diagram illustrating a main part of a control device according to the third example embodiment.

FIG. 23 is a block diagram illustrating a main part of a control device according to a fourth example embodiment.

FIG. 24 is a block diagram illustrating a main part of a wireless communication system according to the fourth example embodiment.

FIG. 25 is a block diagram illustrating a main part of another wireless communication system according to the fourth example embodiment.

### EXAMPLE EMBODIMENT

Hereinafter, example embodiments of the present invention will be described in detail with reference to the accompanying drawings.

### First Example Embodiment

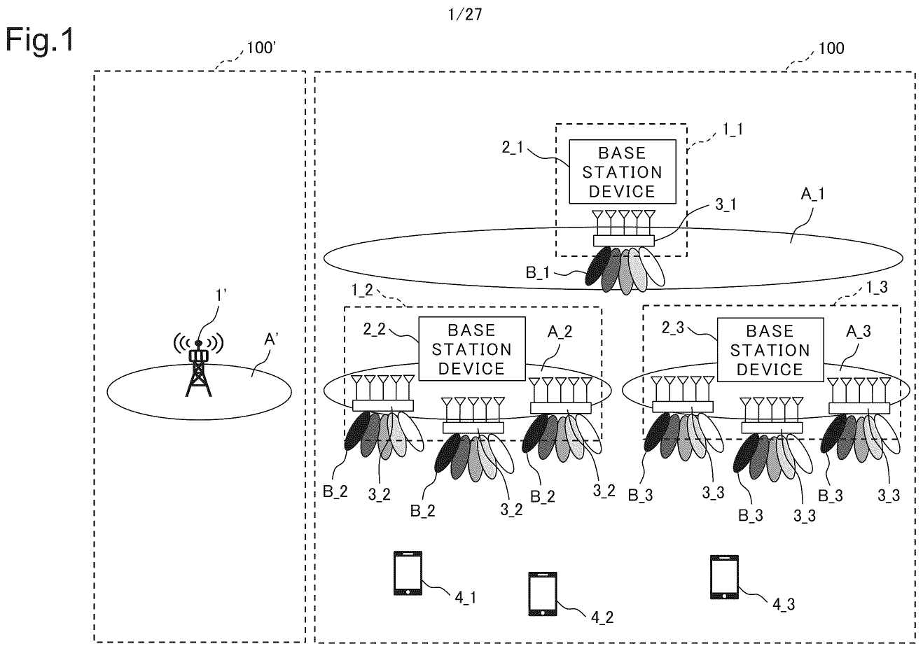

FIG. 1 is an illustration illustrating a main part of a wireless communication system according to a first example embodiment. With reference to FIG. 1, the wireless communication system according to the first example embodiment will be described.

As illustrated in FIG. 1, the wireless communication system 100 includes one or more wireless base stations 1. In an example illustrated in FIG. 1, the wireless communication system 100 includes the three wireless base stations 1_1, 1_2, and 1_3. Each of the wireless base stations 1_2 and 1_3 uses a high frequency band f1 such as a millimeter wave band. Meanwhile, the wireless base station 1_1 uses a frequency band f2 lower than the frequency band f1. The wireless base station 1_1 may use a communication standard different from a communication standard used by each of the wireless base stations 1_2 and 1_3. These communication standards are, for example, the 5th generation (5G), the 4th generation (4G), or wireless local area network (LAN).

In the drawing, A_1, A_2, and A_3 indicate areas associated with respective wireless base stations 1. In the example illustrated in FIG. 1, the area A_1 associated with the wireless base station 1_1 is larger than area A_2 associated with the wireless base station 1_2. The area A_1 associated with the wireless base station 1_1 is larger than the area A_3 associated with the wireless base station 1_3. Herein, the area A_1 may include the areas A_2 and A_3. In other words, each of the areas A_2 and A_3 may be included in the area A_1. Herein, each of the areas can also be referred to as a cell in which the wireless communication is administered by the associated wireless base station 1.

Each of the wireless base stations 1 is constituted of a base station device 2 and one or more base station antennas 3. In the example illustrated in FIG. 1, the wireless base station 1_1 is constituted of the base station device 2_1 and the one base station antenna 3_1. The wireless base station 1_2 is constituted of the base station device 2_2 and the three base station antennas 3_2. The wireless base station 1_3 is constituted of the base station device 2_3 and the three base station antennas 3_3. Herein, the three base station antennas 3_2 are arranged in such a way as to be distributed. The three base station antennas 3_3 are arranged in such a way as to be distributed. In other words, each of the wireless base stations 1_2 and 1_3 uses what are called “distributed antennas”.

Each of the base station antennas 3 includes a plurality of antenna elements. Thereby, each of the base station antennas 3 is compatible with what is called “beamforming”. Herein, “beamforming” is a technique of forming a beam in a specific direction and thereby transmitting a radio wave in the specific direction, or receiving a radio wave from a specific direction. In other words, each of the base station antennas 3 can form a beam in each of a plurality of different directions. In the drawing, B_1, B_2, and B_3 indicate examples of beams formed by the respective base station antennas 3.

In the example illustrated in FIG. 1, the base station antenna 3_1 includes the five antenna elements. Thereby, the base station antenna 3_1 can form the beam B_1 in each of the five mutually different directions. Each of the base station antennas 3_2 includes the five antenna elements. Thereby, each of the base station antennas 3_2 can form the beam B_2 in each of the five mutually different directions. Each of the base station antennas 3_3 includes the five antenna elements. Thereby, each of the base station antennas 3_3 can form the beam B_3 in each of the five mutually different directions.

In addition to this, the wireless communication system 100 can include one or more wireless terminals 4. In the example illustrated in FIG. 1, the wireless communication system 100 includes the three wireless terminals 4_1, 4_2, and 4_3. Each of the wireless terminals 4 is a smartphone, for example. Each of the base station device 2 can communicate with each of the wireless terminals 4 by using the associated base station antenna 3. Such communication is based on the time division duplex (TDD) method or the frequency division duplex (FDD) method, for example. Hereinafter, an example of a case in which such communication is based on the TDD method will be mainly described.

In this manner, the main part of the wireless communication system 100 is configured.

Herein, in the drawing, 100′ indicates a different wireless communication system adjacent to the wireless communication system 100. The wireless communication system 100′ includes a wireless base station 1′. The wireless base station 1′ uses a frequency band f1′ that is equivalent to the frequency band f1. An area A′ associated with the wireless base station 1′ is adjacent to the area A_1, as illustrated in FIG. 1. Alternatively, in some case, the area A′ partially overlaps with the area A_1. Particularly, the area A′ is adjacent to the area A_2, as illustrated in FIG. 1. Alternatively, in some case, the area A′ partially overlaps with the area A_2. Thus, radio wave interference with the wireless communication system 100 caused by the wireless communication system 100′ can occur. Communication in the wireless communication system 100′ is also based on the TDD method or the FDD method, for example. Hereinafter, an example of a case in which such communication is based on the TDD method will be mainly described. Hereinafter, radio wave interference is simply referred to as “interference” in some cases.

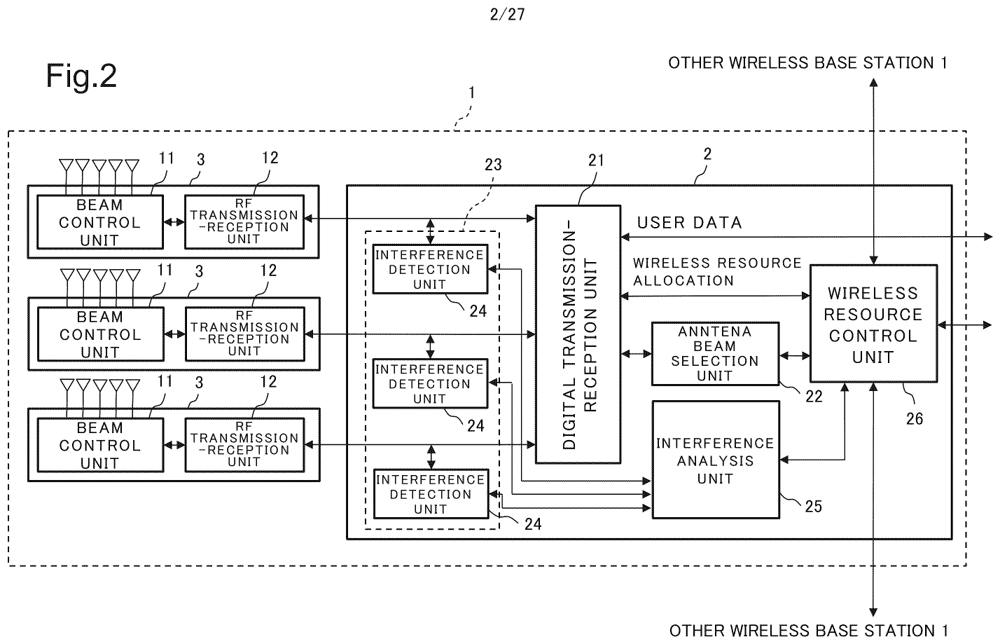

Next, each of the wireless base stations 1 will be described with reference to FIG. 2. In other words, the one wireless base station 1 among the one or more wireless base stations 1 included in the wireless communication system 100 will be described.

As illustrated in FIG. 2, each of the base station antennas 3 includes a beam control unit 11 and a radio frequency (RF) transmission-reception unit 12. The base station device 2 includes a digital transmission-reception unit 21, an antenna beam selection unit 22, and an interference detection unit 23. Herein, the interference detection unit 23 is constituted of an interference detection unit 24 associated with each of the base station antennas 3. In other words, the interference detection unit 23 is constituted of the one or more interference detection units 24 associated with the one or more base station antennas 3. In the example illustrated in FIG. 2, the interference detection unit 23 is constituted of the three interference detection units 24 associated with the three base station antennas 3. The base station device 2 includes an interference analysis unit 25 and a wireless resource control unit 26.

Each of the beam control units 11 executes control for implementing beamforming in the associated base station antenna 3. In other words, as described above, each of the base station antennas 3 includes a plurality of the antenna elements. In other words, each of the base station antennas 3 includes an array antenna. Each of the beam control units 11 determines a beam direction by adjusting phases, amplitudes, and the like of wireless signals for a plurality of such antenna elements. Thereby, the beamforming is implemented. At this time, a specific beam direction or beam number, or the like is specified by the below-described wireless resource control unit 26.

A means for implementing the beamforming in each of the base station antennas 3 is not limited to an array antenna that uses a plurality of the antenna elements. Such beamforming may be implemented by using another directional antenna (a lens antenna, a metamaterial antenna, or the like).

Each of the RF transmission-reception units 12 includes an amplifier (not illustrated), a frequency converter (not illustrated), and the like. Each of the RF transmission-reception units 12 transmits and receives RF signals in the associated base station antenna 3.

The digital transmission-reception unit 21 executes modulation and demodulation of user data. For example, the digital transmission-reception unit 21 executes processing of generating a wireless signal in downlink orthogonal frequency division multiplexing (OFDM) transmission. For example, the digital transmission-reception unit 21 executes processing of demodulating an uplink wireless signal received by a plurality of the antenna elements. In other words, the digital transmission-reception unit 21 executes signal detection of multi input multi output (MIMO).

Herein, a technique such as radio over fiber (RoF), common public radio interface (CPRI), eCPRI, or the like, for example is used for connection between the digital transmission-reception unit 21 and each of the RF transmission-reception units 12. A function of the digital transmission-reception unit 21 may differ depending on a technique used for such connection. The functions of the respective digital transmission-reception units 21 may differ depending on techniques used for such connection.

The antenna beam selection unit 22 selects the base station antenna 3 to be used for communication with each of the wireless terminals 4. Specifically, for example, information indicating a reception level for each of the base station antennas 3 is notified by the wireless terminal 4 that is a target of such communication. Alternatively, information indicating a channel estimation value of a reference signal for each of the base station antennas 3 is notified by the wireless terminal 4 that is a target of such communication. The antenna beam selection unit 22 uses these pieces of information, and thereby, selects the base station antenna 3 to be used for such communication.

Instead of or in addition to this, the antenna beam selection unit 22 selects the beam to be used for communication with each of the wireless terminals 4. Specifically, for example, information indicating a reception level for each of the beams is notified by the wireless terminal 4 that is a target of such communication. Alternatively, information indicating a channel estimation value of a reference signal for each of the beams is notified by the wireless terminal 4 that is a target of such communication. The antenna beam selection unit 22 uses these pieces of information, and thereby, selects the beam to be used for such communication. The beam selected here may be an analog beam controlled by the beam control unit 11, or may be a digital beam controlled by the digital transmission-reception unit 21. The selection of the digital beam and the notification of the information for the selection may be performed for each of frequency resources.

Each of the interference detection unit 24 uses a received signal at the associated base station antenna 3, and thereby, detects occurrence of interference at a spot where the associated base station antenna 3 is installed. Thereby, the interference detection unit 23 detects the occurrence of the interference in the wireless communication system 100. Hereinafter, processing executed by the interference detection unit 23 may be collectively referred to as “interference detection processing” in some cases. A specific example of the interference detection processing will be described later. The interference detection unit 23 outputs information (hereinafter, referred to as “interference detection information” in some cases) indicating a result of interference detection processing.

The received signal used in the interference detection processing is, for example, a received signal that the wireless base station 1 receives in a time zone associated with a reception section of the TDD, or a received signal that both of the wireless base station 1 and the wireless terminal 4 receive in a time zone associated with a non-transmission section of the TDD. Alternatively, the received signal used in the interference detection processing is, for example, a received signal in a time zone associated with a section in which what is called “network listening” is executed. Herein, “network listening” means measuring a reception level of a reference signal transmitted by different adjacent wireless base stations (1, 1′), with the wireless base station 1 transmitting no signal, in a time zone in which the wireless base station 1 is normally expected to transmit a signal. Hereinafter, a section in which the network listening is performed is referred to as “network listening section” in some cases.

Hereinafter, at least one of temporal consecutiveness of interference, temporal continuity of interference, and temporal periodicity of interference is collectively referred to as “temporal consecutiveness” in some cases. At least one of spatial consecutiveness of interference and a spatial spread of interference is collectively referred to as “spatial consecutiveness” in some cases. At least one of the temporal consecutiveness and the spatial consecutiveness is collectively referred to simply as “consecutiveness” in some cases.

The interference analysis unit 25 analyzes interference detection information (i.e., analyzes a result of interference detection processing), and thereby estimates at least one of temporal consecutiveness and spatial consecutiveness of the above-described detected interference. As described above, the temporal consecutiveness includes temporal consecutiveness, temporal continuity, temporal periodicity, or the like. Spatial consecutiveness includes spatial consecutiveness, a spatial spread, or the like. Based on the estimated consecutiveness, the interference analysis unit 25 predicts whether control (“wireless resource control for interference” described later) executed by the below-described wireless resource control unit 26 needs to be executed.

Hereinafter, an example of a case in which the interference analysis unit 25 estimates both temporal consecutiveness and spatial consecutiveness will be mainly described. Hereinafter, processing executed by the interference analysis unit 25 is collectively referred to as “interference analysis processing” in some cases. A specific example of the interference analysis processing will be described later. The interference analysis unit 25 outputs information (hereinafter, referred to as “interference analysis information” in some cases) indicating a result of the interference analysis processing.

The wireless resource control unit 26 executes allocation control of wireless resources in the wireless communication system 100. Specifically, for example, the wireless resource control unit 26 executes allocation control of wireless resources within the associated wireless base station 1. The allocation of such wireless resources is used in transmission-reception control and signal processing in the digital transmission-reception unit 21, and can be notified to each of the base station antennas 3 via the digital transmission-reception unit 21. For example, the wireless resource control unit 26 cooperates with the wireless resource control unit 26 of the other wireless base station 1, and thereby executes the allocation control of the wireless resources between or among the wireless base stations 1 in the wireless communication system 100. In other words, the allocation control of wireless resources between the wireless base stations 1 may be implemented by what is called “distribution control”. The wireless resources as targets allocated by the wireless resource control unit 26 can include various resources (the wireless base stations, the base station antennas, the beams, frequencies, times, and the like).

The allocation control of the wireless resources between or among the wireless base stations 1 may include control (hereinafter, referred to as “load distribution control”) of distributing loads between or among the wireless base stations 1. For example, the load distribution control may include at least one of: control of executing what is called “handover”; control of executing what is called “carrier aggregation”; and control of executing what is called “dual connectivity”. Instead of or in addition to this, the load distribution control may include control of allocating what is called “network slices”.

Herein, “carrier aggregation” is a technique of simultaneously using a plurality of frequency bands, and thereby making a communication speed higher or making communication more stable. The “dual connectivity” is a technique of simultaneously connecting to a plurality of wireless base stations, and thereby making carrier aggregation. The “network slices” are respective divided slices in a technique (what is called “network slicing”) of virtually dividing a network.

Herein, the wireless resource allocation control executed by the wireless resource control unit 26 includes control of allocating the wireless resources in order to reduce influence of the above-described detected interference, depending on the interference analysis information (i.e., depending on a result of the interference analysis processing). Hereinafter, such control will be referred to as “wireless resource control for interference” or “wireless resource control”. A specific example of the wireless resource control for interference will be described later.

In this manner, the main part of the wireless base station 1 is configured.

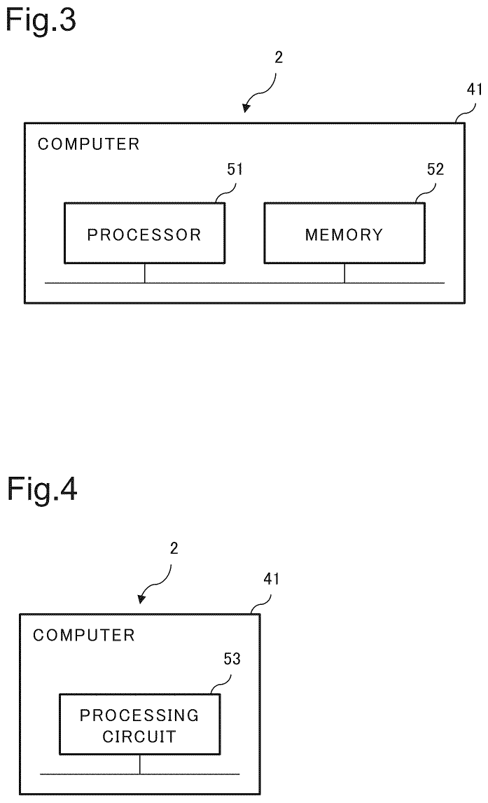

Next, a hardware configuration of a main part of the base station device 2 will be described with reference to FIG. 3 to FIG. 5.

As illustrated in each of FIG. 3 to FIG. 5, the base station device 2 uses a computer 41.

As illustrated in FIG. 3, the computer 41 includes a processor 51 and a memory 52. The memory 52 stores a program for causing the computer 41 to function as the digital transmission-reception unit 21, the antenna beam selection unit 22, the interference detection unit 23, the interference analysis unit 25, and the wireless resource control unit 26. The processor 51 reads out and executes the program stored in the memory 52. Thereby, a function F1 of the digital transmission-reception unit 21, a function F2 of the antenna beam selection unit 22, a function F3 of the interference detection unit 23, a function F4 of the interference analysis unit 25, and a function F5 of the wireless resource control unit 26 are implemented.

Alternatively, as illustrated in FIG. 4, the computer 41 includes a processing circuit 53. The processing circuit 53 executes processing for causing the computer 41 to function as the digital transmission-reception unit 21, the antenna beam selection unit 22, the interference detection unit 23, the interference analysis unit 25, and the wireless resource control unit 26. Thereby, the functions F1 to F5 are implemented.

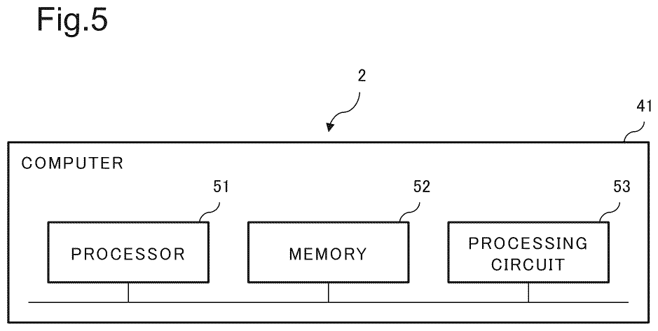

Alternatively, as illustrated in FIG. 5, the computer 41 includes the processor 51, the memory 52, and the processing circuit 53. In this case, a prat of the functions F1 to F5 is implemented by the processor 51 and the memory 52, and the remaining part of the functions F1 to F5 is implemented by the processing circuit 53.

The processor 51 is constituted of one or more processors. Each of the processor uses a central processing unit (CPU), a graphics processing unit (GPU), a microprocessor, a microcontroller, or a digital signal processor (DSP), for example.

The memory 52 is constituted of one or more memories. Each of the memories uses a random access memory (RAM), a read only memory (ROM), a flash memory, an erasable programmable read only memory (EPROM), an electrically erasable programmable read only memory (EEPROM), a solid state drive, a hard disk drive, a flexible disc, a compact disc, a digital versatile disc (DVD), a blue-ray disc, a magneto optical (MO) disc, or a mini disc, for example.

The processing circuit 53 is constituted of one or more processing circuits. Each of the processing circuit uses an application specific integrated circuit (ASIC), a programmable logic device (PLD), a field programmable gate array (FPGA), a system on a chip (SoC), or system large scale integration (LSI), for example.

The processor 51 may include a dedicated processor associated with each of the functions F1 to F5. The memory 52 may include a dedicated memory associated with each of the functions F1 to F5. The processing circuit 53 may include a dedicated processing circuit associated with each of the functions F1 to F5.

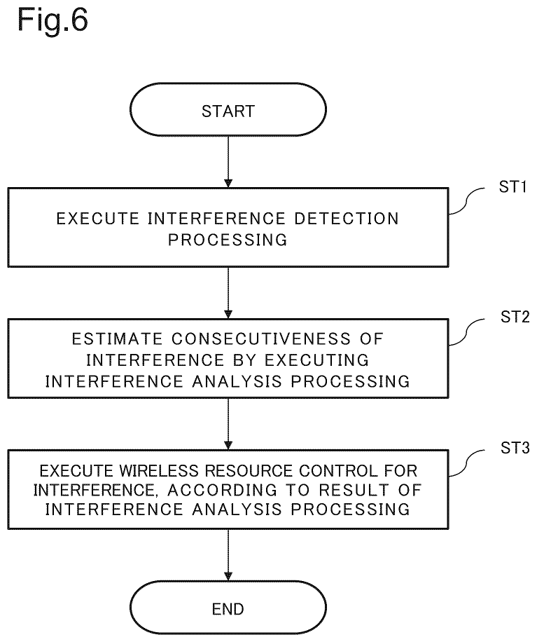

Next, with reference to a flowchart illustrated in FIG. 6, description will be made on operation of the base station device 2, mainly on operation of the interference detection unit 23, the interference analysis unit 25, and the wireless resource control unit 26.

First, the interference detection unit 23 executes interference detection processing (step ST1). A specific example of the interference detection processing will be described later. Next, the interference analysis unit 25 executes interference analysis processing (step ST2). Thereby, consecutiveness of interference detected by the interference detection processing is estimated. A specific example of the interference analysis processing will be described later. Next, the wireless resource control unit 26 executes wireless resource control for interference, depending on a result of the interference analysis processing (step ST3). A specific example of the wireless resource control for interference will be described later.

Next, a specific example of the interference detection processing will be described.

The interference detection unit 23 detects occurrence of the interference by using any one of the following first to third detection methods, for example. Alternatively, the interference detection unit 23 detects occurrence of the interference by using a combination of any two or more of these detection methods.

### <First Detection Method>

The first detection method uses a received signal that the wireless base station 1 receives in a time zone associated with a reception section in the TDD, or received signals that both of the wireless base station 1 and the wireless terminal 4 receive in a time zone associated with a non-transmission section in the TDD. Each of the interference detection units 24 extracts a predetermined feature value from the received signal at the associated base station antenna 3. Each of the interference detection units 24 inputs the detected feature value to a predetermined trained model. Herein, such a trained model has been trained in advance in such a way as to output, in response to the input of such a feature value, information indicating presence or absence of the interference and information indicating a degree of the interference that is present. Such training is to use the one-class support vector machine (SVM) or the like, for example, and thereby learn, by what is called “unsupervised learning”, the past feature value in a state (i.e., a normal state at the time of the operation) in which no interference is present. In other words, such a trained model is generated by such unsupervised learning.

For example, a statistical value of a reception level in a fixed period is used as the feature value in the first detection method, for each frequency resource (a resource block: RB). More specifically, for example, a value (information or data) converted from such a reception level by a probability density function (PDF) or by a cumulative distribution function (CDF) is used.

Alternatively, for example, when a received signal in a time zone associated with the above-described reception section is used, a reception level or a channel estimation value of an uplink reference signal is used as such a feature value. More specifically, for example, a reception level or a channel estimation value of a demodulation reference signal (DMRS), a sounding reference signal (SRS), or the like is used.

It can be said that detecting occurrence of the interference is determining presence or absence of the interference. In the first detection method, the interference detection information output by the interference detection unit 23 includes, for example, a value (e.g., a value indicating a normality degree or an abnormality degree) that is an index for such determination. Hereinafter, such a value is referred to as “index value” in some cases. The output interference detection information includes, for example, the extracted feature value (a reception level or the like for each frequency resource).

### <Second Detection Method>

A received signal used in the second detection method is similar to the received signal used in the first detection method. Each of the interference detection units 24 executes analytical computation by using the received signal at the associated base station antenna 3, and thereby determines whether or not a predefined interference state exists. For example, such analytical computation may use a threshold value set at a level of a noise floor. Alternatively, for example, such analytical computation may use a reference set at a reception level or a channel estimation value of an uplink reference signal.

Alternatively, each of the interference detection units 24 extracts a predetermined feature value from the received signal at the associated base station antenna 3. Each of the interference detection units 24 inputs the detected feature value to a predetermined trained model. Herein, such a trained model has been trained in advance in such a way as to output, in response to the input of such a feature value, information indicating presence or absence of the interference and information indicating a degree of the interference that is present. Such training is to learn, by what is called “supervised learning”, the past feature value in a state in which the interference is present. In other words, such a trained model is generated by such supervised learning.

For example, a value similar to a value (a level of a noise floor, a reception level or a channel estimation value of an uplink reference signal, or the like) used in analytical computation is used as a feature value in a case of using the supervised learning. When an interfering wireless communication system (e.g., the wireless communication system 100′ illustrated in FIG. 1) or wireless device (e.g., the wireless base station 1′ illustrated in FIG. 1) is known, using the supervised learning is also effective. Similarly to the case that is the first detection method and that uses the unsupervised learning, a statistical feature value (such as a PDF or a CDF) may be used as the feature value.

### <Third Detection Method>

The third detection method uses a received signal in a time zone associated with the network listening section. In other words, basically, a reference signal from an adjacent wireless base station (e.g., the other wireless base station 1 illustrated in FIG. 1) is used. Each of the interference detection units 24 extracts a predetermined feature value from the received signal at the associated base station antenna 3. Information indicating a reception level (i.e., reception quality) of such a reference signal is used as the feature value. Each of the interference detection units 24 inputs the extracted feature value to a trained model generated by unsupervised learning similar to that in the first detection method or supervised learning similar to that in the second detection method. Alternatively, each of the interference detection units 24 performs analytical computation and determination similarly to the second detection method. Thereby, occurrence of the interference is detected. By using such a detection method, occurrence of the interference in a section in which the wireless base station 1 is expected to transmit a signal can be also detected.

A reception level used in the interference detection processing is reference signal received power (RSRP), a received signal strength indicator (RSSI), reference signal received quality (RSRQ), a signal to interference plus noise ratio (SINR), or the like, for example.

The interference detection processing may be executed for each of the slot numbers (hereinafter, referred to as “TDD slot numbers” or simply as “slot numbers”) in a TDD configuration. This can be applied to any of the first detection method, the second detection method, and the third detection method.

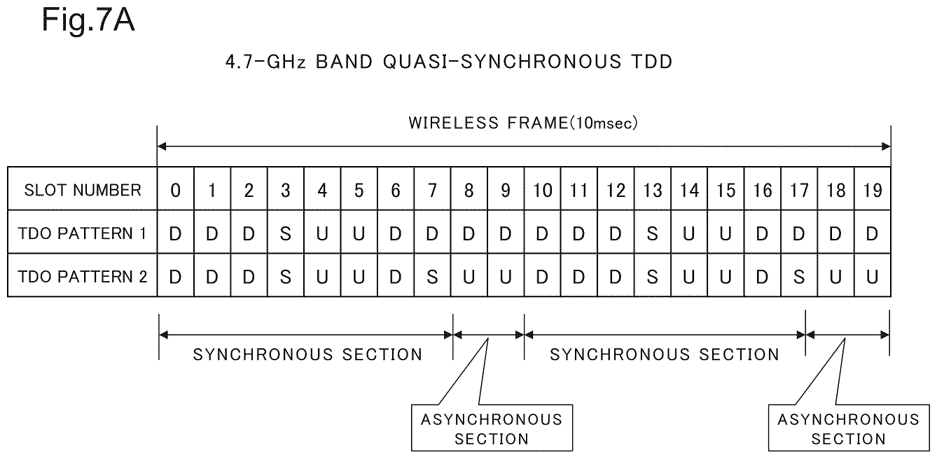

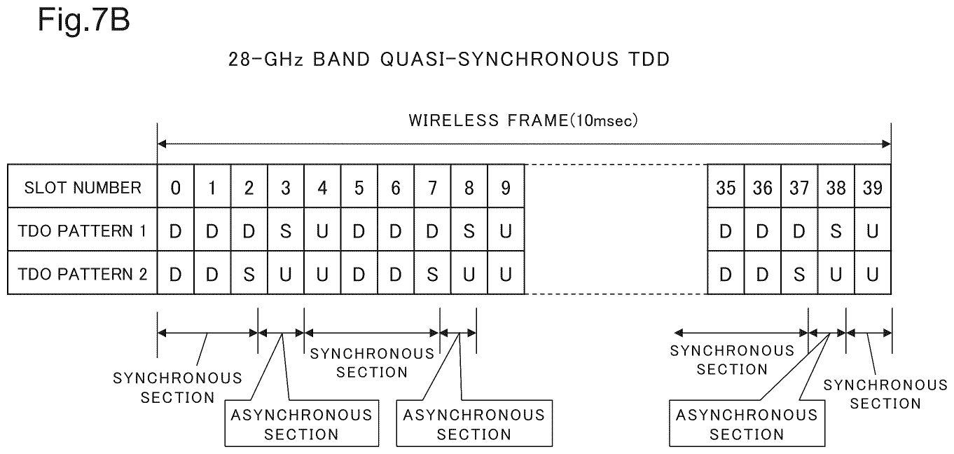

For example, first, it is assumed that the wireless communication systems 100 and 100′ use quasi-synchronous TDD. FIG. 7A and FIG. 7B each illustrate an example of TDD time slots in the quasi-synchronous TDD. It is assumed that in the example of the quasi-synchronous TDD of the 4.7-GHz band (refer to FIG. 7A), the wireless communication system 100′ uses “TDD pattern 1” in the drawing, and the wireless communication system 100 uses “TDD pattern 2” in the drawing. In this case, for example, in time slots of the number 8 (“#8” in the drawing) and the number 9 (“#9” in the drawing), the wireless communication system 100 corresponds to an uplink slot (“U” in the drawing), and meanwhile, the wireless communication system 100′ corresponds to a downlink slot (“D” in the drawing). In this manner, in the quasi-synchronous TDD, what is called “asynchronous sections” exist.

In time slots associated with such an asynchronous section, there is a high possibility that a reception level (interference level) of a received signal used in the interference detection processing is higher than that in different time slots. Thus, the interference detection processing may be executed for each of the slot numbers, depending on whether each time slot is a time slot associated with the asynchronous section or a time slot associated with a synchronous section.

In the drawing, “S” indicates what is called “special subframe”. The special subframe is a slot at the time of switching in which a downlink (DL), a non-transmission section, and an uplink (UL) are mixed. Thus, even in the special subframe, a downlink signal can be transmitted (DL).

Secondly, when the TDD configurations of the wireless base stations 1 included in the wireless communication system 100 are the same, the network listening section is a section in which all the wireless base stations 1 are expected to transmit signals (a section in which the wireless base stations 1 do not transmit signals in spite of that). Thus, there is a possibility that using a received signal in the network listening section enables detection of the interference (e.g., the interference caused by a wireless base station of the different wireless communication system) that cannot be detected by using a received signal in a reception section.

Each of pieces of the interference detection processing may be executed in cooperation with beam control executed by the associated beam control unit 11. Thereby, for example, the interference detection processing may be executed for each beam (i.e., for each beam direction), for each of the base station antennas 3. In this case, the interference detection information output by the interference detection unit 23 may include information (hereinafter, referred to as “beam information” in some cases) indicating the associated beam, in addition to including the above-described index value and the above-described feature value.

Next, a specific example of the interference analysis processing will be described.

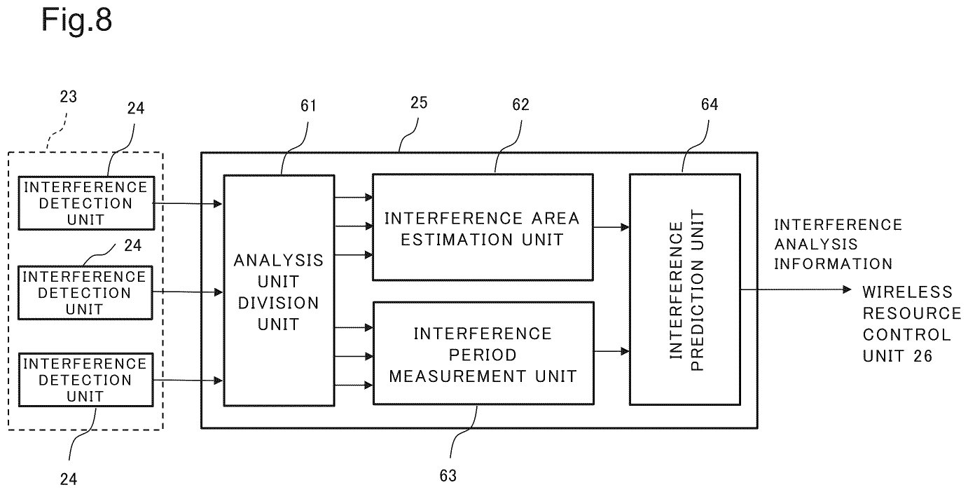

FIG. 8 is a block diagram illustrating an example of a main part of the interference analysis unit 25. In the example illustrated in FIG. 8, the interference analysis unit 25 includes an analysis unit division unit 61, an interference area estimation unit 62, an interference period estimation unit 63, and an interference prediction unit 64. The unidirectional arrows in FIG. 8 indicate directions of flows of certain signals (data), for convenience of description, and do not exclude bidirectionality.

The analysis unit division unit 61 divides the interference analysis information per predetermined unit, and outputs the divided interference analysis information to each of the interference area estimation unit 62 and the interference period estimation unit 63. Thereby, estimation of consecutiveness is executed, for each of such units, in each of the interference area estimation unit 62 and the interference period estimation unit 63 (description is made later).

Such a unit is constituted by at least one of a TDD slot number and a frequency resource (RB), for example. In other words, for example, the analysis unit division unit 61 divides the interference analysis information per predetermined number of the TDD slot numbers. Alternatively, for example, the analysis unit division unit 61 divides the interference analysis information per predetermined number of the RBs. Alternatively, for example, the analysis unit division unit 61 divides the interference analysis information per predetermined number of the TDD slot numbers and per predetermined number of the RBs.

The interference area estimation unit 62 estimates spatial consecutiveness by using the divided interference detection information. Specifically, for example, the interference area estimation unit 62 estimates spatial consecutiveness for each of the above-described units by using any one of the following first to third estimation methods.

### <First Estimation Method>

The first estimation method estimates spatial consecutiveness by linear interpolation and extrapolation, by using the interference detection information associated with a plurality of the base station antennas 3.

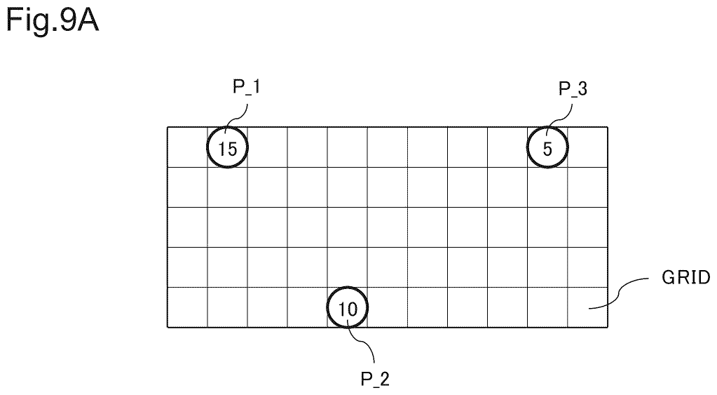

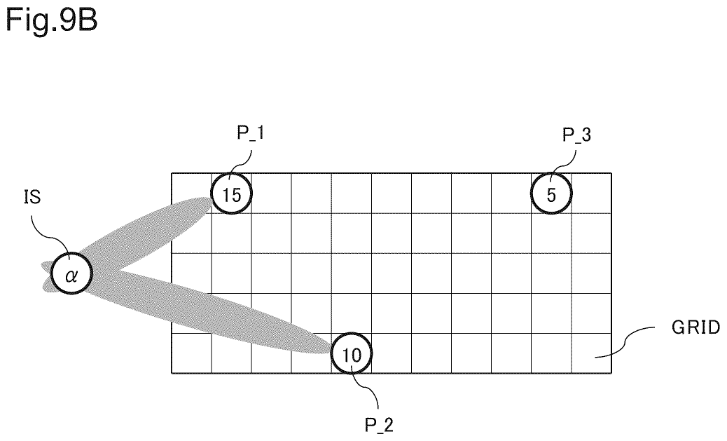

In other words, the interference area estimation unit 62 divides the area A of the associated wireless base station 1 per predetermined range, and thereby sets a plurality of grids. The interference area estimation unit 62 plots an index value indicated by the interference detection information associated with each of the base station antennas 3, in the grid associated with a position of each of the base station antennas 3. FIG. 9A illustrates an example of a state in which the index values are plotted. In the drawing, each of P_1 to P_3 is associated with a position of the base station antenna 3. The numerical values (15, 10, 5) written in each of P_1 to P_3 indicate the index values computed in the interference detection processing.

Next, the interference area estimation unit 62 executes linear interpolation, and thereby estimates index values in the grids between positions (P in the drawing) of each pair of the two base station antennas 3. Next, the interference area estimation unit 62 executes linear extrapolation, and thereby estimates index values in the remaining grids included in the grids associated with a straight line that connects the positions of each pair of the two base station antennas 3. Next, the interference area estimation unit 62 uses these estimated index values, and thereby estimates index values in the remaining grids in the area A by a similar method (i.e., interpolation or extrapolation).

Thereby, the index values in all the grids associated with the area A are estimated. In other words, spatial consecutiveness of the interference is estimated.

### <Second Estimation Method>

The second estimation method uses a spatial interpolation technique different from the first estimation method. Specifically, for example, the second estimation method uses a kriging method. Herein, the kriging method is a method in which based on distribution of data acquired by measurement or analysis at a plurality of mutually different positions, a value at another position is estimated.

In other words, the interference area estimation unit 62 sets a plurality of grids similarly to the first estimation method. The interference area estimation unit 62 plots an index value indicated by the interference detection information associated with each of the base station antennas 3, in the grid associated with the position of each of the base station antennas 3. Next, the interference area estimation unit 62 executes spatial interpolation by the kriging method, and thereby estimates index values in the remaining grids. Thereby, the index values in all the grids associated with the area A are estimated. In other words, the spatial consecutiveness of the interference is estimated.

### <Third Estimation Method>

As described above, the interference detection information output by the interference detection unit 23 may include beam information. The third estimation method uses the beam information.

In other words, the interference area estimation unit 62 sets a plurality of grids similarly to the first estimation method. The interference area estimation unit 62 plots an index values indicated by the interference detection information associated with each of the base station antennas 3, in the grid associated with the position of each of the base station antennas 3.

Next, the interference area estimation unit 62 uses the beam information, and thereby determines a beam (i.e., a beam in which occurrence of the interference is detected) associated with a high index value, for each of the base station antennas 3. This determines the beam in which occurrence of the interference is detected, at an installation position (i.e., each spot where occurrence of the interference is detected; hereinafter, such a spot is referred to as “interference detection spot” in some cases) of the base station antenna 3 where occurrence of the interference is detected. The interference area estimation unit 62 computes an intersection point of straight lines associated with these beam directions, and thereby estimates a position of an interference source. Thereby, a direction of the interference source relative to each of the base station antennas 3 is also determined. FIG. 9B illustrates an example of a state in which the position of the interference source (IS in the drawing) is determined.

Next, the interference area estimation unit 62 assumes a radio wave propagation model or the like, uses a kriging-with-trend method or a regression kriging method, and thereby computes coefficients (propagation constants or the like) in the radio wave propagation model including an index value (a in the drawing) at the position of the interference source and computes an index value in each of the grids. Thereby, all the index values in all the grids associated with the area A are estimated. In other words, spatial consecutiveness of the interference is estimated.

Herein, the radio wave propagation model is expressed by the following equations, for example. In the following equation, α is the propagation constant, and is generally a parameter related to a transmission output of a radio wave. The propagation coefficient α in the following equation is different from the index value α in FIG. 9B. The sign β is a parameter related to an attenuation rate for a unit distance. The sign dₙ(φ) represents a distance between a reception antenna n and an emission source. The sign φ=(x, y, z) represents position coordinates of the radio wave emission source. The sign (xₙ₁, xₙ₂, xₙ₃) represents position coordinates of the reception antenna n.

$${\tilde{m}}_{n} ( ϕ ) = α \cdot {{d}_{n} ( ϕ )}^{- β} \qquad [ Math 1 ]$$

$${d}_{n} ( ϕ ) = \sqrt{{( x - {x}_{n 1} )}^{2} + {( y - {x}_{n 2} )}^{2} + {( z - {x}_{n 3} )}^{2}} \qquad [ Math 2 ]$$

However, the radio wave propagation model in estimation of spatial consecutiveness is not limited to this. Various known models can be used as the radio wave propagation model in estimation of spatial consecutiveness.

The interference period estimation unit 63 estimates temporal consecutiveness by using the above-described divided interference detection information. Specifically, for example, the temporal consecutiveness is estimated for each of the above-described units as follows.

In other words, the interference period estimation unit 63 uses the interference detection information for a fixed period, and thereby estimates temporal consecutiveness, continuity, or periodicity of the interference in the period. Specifically, for example, the interference period estimation unit 63 successively computes a duration time, an intermittence cycle, or the like of the interference for each fixed period.

Alternatively, for example, when a wireless communication system (e.g., the wireless communication system 100′ illustrated in FIG. 1) as the interference source is known, the interference period estimation unit 63 estimates the temporal consecutiveness by a method similar to the second detection method in the interference detection unit 23. In other words, the interference period estimation unit 63 executes analytical computation by using the interference detection information for a fixed period, and thereby estimates the temporal consecutiveness of the interference in the period. Alternatively, the interference period estimation unit 63 inputs the interference detection information for a fixed period to a trained model generated by prior supervised learning, and thereby estimates the temporal consecutiveness of the interference in the period.

Herein, “fixed period” related to the estimation of the temporal consecutiveness is a period having a predetermined length (e.g., 20 frames=0.2 seconds) set based on a TDD wireless frame (10 milliseconds in the examples illustrated in FIG. 7A and FIG. 7B).

The interference period estimation unit 63 may use information indicating a result of estimation for a fixed period executed by the interference area estimation unit 62, instead of using the interference detection information for a fixed period. In other words, the estimation of the temporal consecutiveness of the interference may be executed for each of the base station antennas 3, or may be executed for the area A.

The interference prediction unit 64 predicts, based on results of the estimation by the interference area estimation unit 62 and the interference period estimation unit 63, whether the detected interference is interference for which the wireless resource control for interference needs to be executed. In other words, the interference prediction unit 64 predicts the consecutiveness of the detected interference, and thereby predicts whether the detected interference is interference for which the wireless resource control for interference is necessary.

In other words, the interference prediction unit 64 quantifies a degree of a spatial spread (i.e., spatial consecutiveness) of the above-described detected interference, based on a result of the estimation by the interference area estimation unit 62. Such a quantified value (hereinafter, referred to as “first estimated value” in some cases) is based on, for example, an average value of the index values in a plurality of the grids associated with the area A, or the number of the grids each having the index value that exceeds a predetermined threshold. Similarly, the interference prediction unit 64 quantifies a degree of a temporal spread (i.e., temporal consecutiveness, continuity, or periodicity) of the above-described detected interference, based on a result of the estimation by the interference period estimation unit 63. Hereinafter, such a quantified value is referred to as a “second estimated value” in some cases.

Next, the interference prediction unit 64 computes a multiplication value by the first estimated value and the second estimated value. When the computed multiplication value exceeds a predetermined reference value, the interference prediction unit 64 determines that it is necessary to execute control (i.e., wireless resource control) of the wireless resources for reducing influence of the above-described detected interference. Meanwhile, when the computed multiplication value is equal to or less than the reference value, the interference prediction unit 64 predicts that execution of such wireless resource control is unnecessary.

Thereby, it is predicted that execution of the wireless resource control for interference is unnecessary, for example, when the above-described detected interference occurs in such a way as to be at a spatial pinpoint, and such interference occurs in such a way as to be at a temporal pinpoint (i.e., occurs instantaneously). It is predicted that execution of the wireless resource control for interference is necessary, for example, when the above-described detected interference occurs in such a way as to spatially spread (i.e., has spatial consecutiveness), and such interference occurs in such a way as to temporally spread (i.e., has temporal consecutiveness, continuity, or periodicity).

The interference prediction unit 64 outputs information (hereinafter, referred to as “interference prediction information” in some cases) indicating a result of such prediction. In other words, the interference analysis information output by the interference analysis unit 25 includes the interference prediction information.

As described above, the estimation by each of the interference area estimation unit 62 and the interference period estimation unit 63 can be executed for each of the predetermined units (e.g., for each of a predetermined number of the TDD slot numbers or for each of a predetermined number of the RBs). Thus, each of the first estimated value and the second estimated value may be computed for each of the units, and a multiplication value by the first estimated value and the second estimated value may be computed for each of the units. Alternatively, a multiplication value of the computed first estimated value, the computed second estimated value, and a value indicating the number of the associated RBs may be computed for each of the TDD slot numbers. In this case, the interference prediction unit 64 may compute a total value by these multiplication values, compare the total value with a predetermined reference value, and thereby predict whether execution of the wireless resource control is necessary.

The interference analysis unit 25 does not need to include the analysis unit division unit 61.

In this case, the estimation of temporal consecutiveness and spatial consecutiveness may be executed without dividing the interference detection information per unit described above.

The interference analysis unit 25 may include the interference area estimation unit 62 or the interference period estimation unit 63, instead of including the interference area estimation unit 62 and the interference period estimation unit 63. In other words, the interference analysis unit 25 may estimate temporal consecutiveness or spatial consecutiveness, instead of estimating each of temporal consecutiveness and spatial consecutiveness. In this case, the interference prediction unit 64 may use the first estimated value or the second estimated value for prediction, instead of using the multiplication value by the first estimated value and the second estimated value.

Next, a specific example of the wireless resource control for interference will be described.

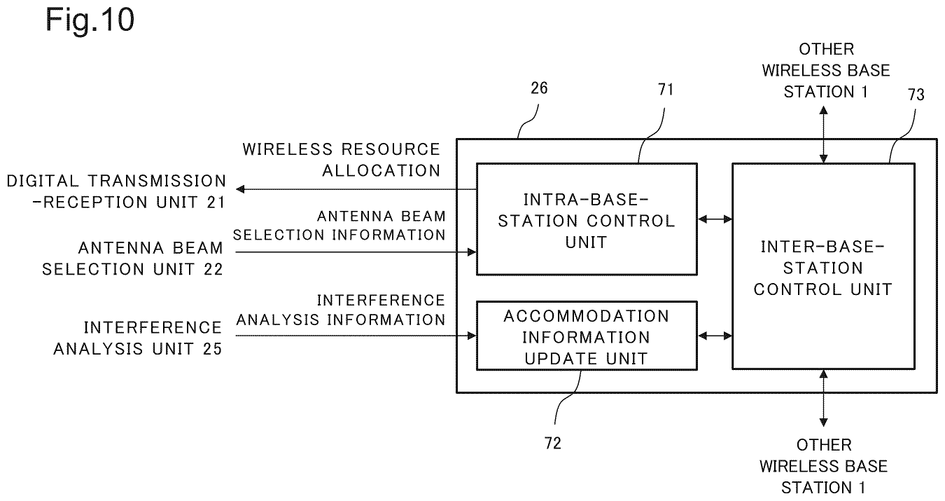

FIG. 10 is a block diagram illustrating an example of a main part of the wireless resource control unit 26. In the example illustrated in FIG. 10, the wireless resource control unit 26 includes an intra-base-station control unit 71, an accommodation information update unit 72, and an inter-base-station control unit 73. The unidirectional arrows in FIG. 10 simply indicates directions of flows of certain signals (data), and do not exclude bidirectionality.

The intra-base-station control unit 71 executes the allocation control of the wireless resources within the associated wireless base station 1. In other words, the intra-base-station station control unit 71 acquires information (hereinafter, referred to as “terminal information”) concerning each of the wireless terminals 4. For example, the terminal information includes information concerning scheduling of each of the wireless terminals 4, and information concerning application software (hereinafter, referred to as “app”) and a communication protocol (hereinafter, referred to as “protocol”) that are being executed in each of the wireless terminals 4. More specifically, the terminal information includes information indicating a priority degree of the app or the protocol, information indicating a type of the app or the protocol, information indicating a network slice allocated to the app or the protocol, and information indicating an expected traffic volume of the protocol. The intra-base-station station control unit 71 acquires information (hereinafter, referred to as “antenna beam selection information”) indicating a current state of selection performed by the antenna beam selection unit 22, for each of the wireless terminals 4. The intra-base-station station control unit 71 uses these pieces of the information, and thereby determines allocation of the specific wireless resources (the base station antenna, the beam, a frequency, a time, and the like) used for communication to each of the wireless terminal 4.

The accommodation information update unit 72 updates accommodation information of the associated wireless base station 1, based on the interference analysis information (more specifically, the interference prediction information). For example, the accommodation information indicates the number (hereinafter, referred to as “accommodable terminal number”) of the wireless terminals 4 accommodable in the associated wireless base station 1, or indicates a volume (hereinafter, referred to as “accommodable traffic volume”) of traffic accommodable in the associated wireless base station 1. For example, when it is predicted that the above-described detected interference has consecutiveness, the accommodation information update unit 72 causes a value of the accommodable terminal number or an accommodable traffic volume included in the accommodation information, to be smaller than that when it is not so.

The inter-base-station control unit 73 cooperates with the inter-base-station control unit 73 of the other wireless base station 1, and thereby executes the allocation control of the wireless resource between or among the wireless base stations 1. As described above, such control includes the control of load distribution between or among the wireless base stations 1. The load distribution control can include control of executing a handover. Herein, the handover is executed based on the terminal information concerning the wireless terminals 4 accommodated in each of the wireless base stations 1, and information indicating a result of measurement for determining whether the handover is allowed for each of the wireless terminals 4. In addition to this, the handover is executed based on the accommodation information.

For example, it is assumed that the accommodation information is updated based on the interference prediction information, and a value of the accommodable terminal number or the accommodable traffic volume in the certain wireless base station 1 is reduced. There is a possibility that what is called “accommodation risk” thereby occurs. In response to this, the handover depending on such reduction is executed.

For example, in the example illustrated in FIG. 1, it is assumed that interference having consecutiveness occurs in the area A_2, and thereby, the accommodable terminal number (or the accommodable traffic volume) in the wireless base station 1_2 is reduced. In response to this, the inter-base-station control unit 73 of the wireless base station 1_2 cooperates with the inter-base-station control unit 73 of the wireless base station 1_3, and thereby, handover from the wireless base station 1_2 to the wireless base station 1_3 is executed concerning selected one of the wireless terminals 4 accommodated in the wireless base station 1_2. Thereby, the selected wireless terminal 4 is accommodated in the adjacent wireless base station 1_3 that uses the same frequency band f1.

Alternatively, the inter-base-station control unit 73 of the wireless base station 1_2 cooperates with the inter-base-station control unit 73 of the wireless base station 1_1, and thereby, the handover from the wireless base station 1_2 to the wireless base station 1_1 is executed concerning the wireless terminal 4 (or an associated network slice) that is among the wireless terminal 4 accommodated in the wireless base station 1_2 and that does not need large-capacity transmission (i.e., high-speed communication via a broadband). Thereby, such a wireless terminal 4 is accommodated in the wireless base station 1_1 that uses the smaller frequency band f2.

As described above, the load distribution control is not limited to the control of executing the handover. For example, the load distribution control may be control of executing carrier aggregation, or control of executing dual connectivity,

Instead of or in addition to the allocation control of the wireless resources between or among the wireless base stations 1, wireless resource allocation control within the wireless base station 1 may be executed based on the accommodation information. In other words, instead of or in addition to the allocation control of the wireless resources between or among the wireless base stations 1, the allocation control of the wireless resources within the wireless base station 1 may be executed depending on a result of the prediction of occurrence of consecutive interference. In other words, the wireless resource control for interference may include the allocation control of the wireless resources within the wireless base station 1 instead of or in addition to the allocation control of the wireless resources among the wireless base stations 1.

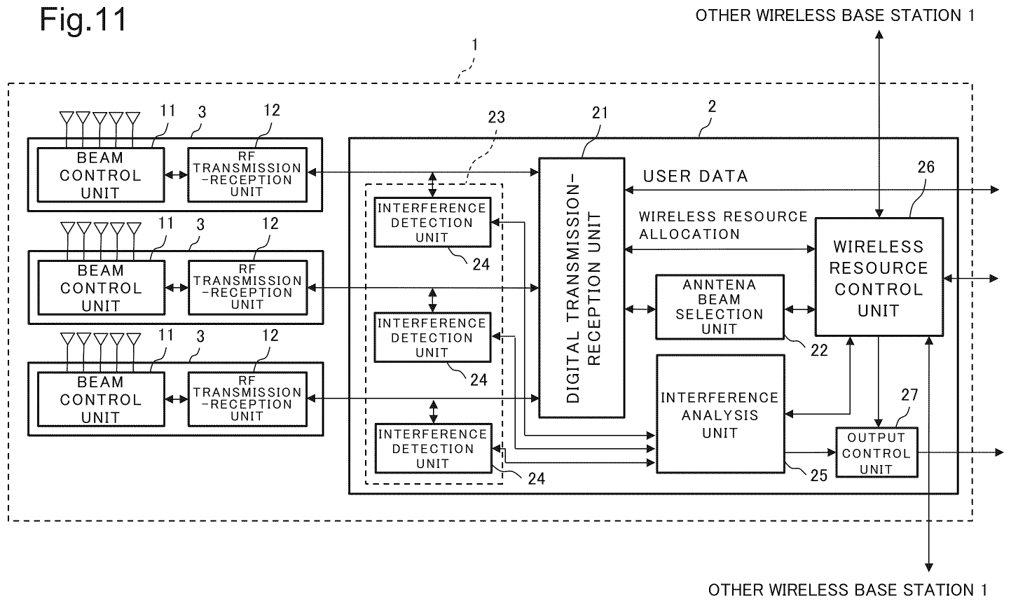

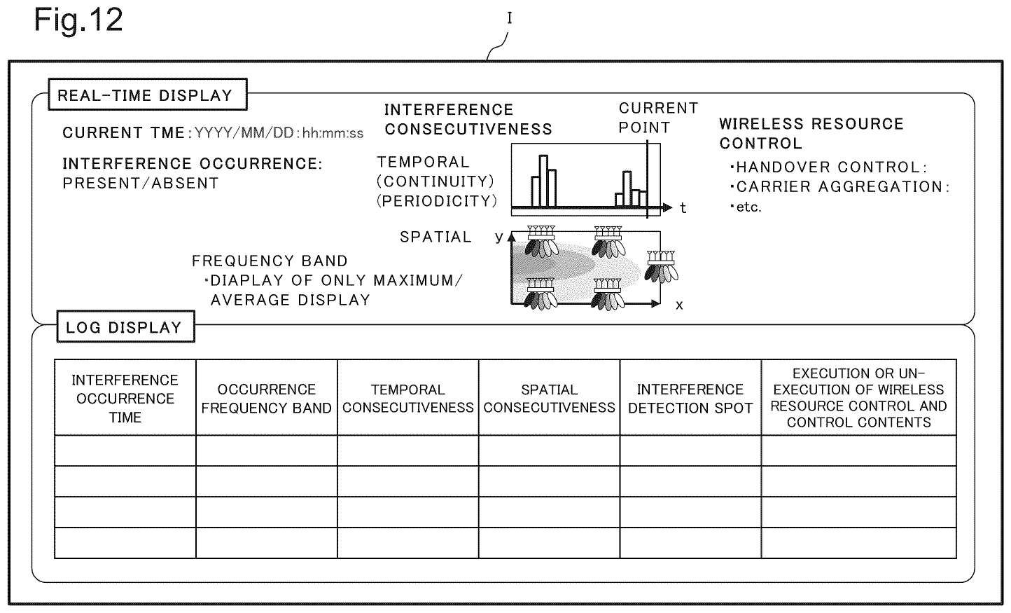

Next, a modified example of the wireless base station 1 will be described with reference to FIG. 11 and FIG. 12.

As illustrated in FIG. 11, the wireless base station 1 may include an output control unit 27. The output control unit 27 executes control of outputting information (hereinafter, referred to as “wireless resource control information”) and the like concerning the wireless resource control for interference that is to be executed or has been executed by the wireless resource control unit 26 and the interference analysis information. Thereby, these pieces of the information are output to an outside. These pieces of the information may be output as data by using an application programming interface (API) or the like, may be stored as such data in a recording medium, or may be output (displayed or provided) as an image I by using a user interface (UI). FIG. 12 illustrates an example of such an image I.

In the example illustrated in FIG. 12, the image I includes a “real-time display” field and a “log display” field. In the real-time display field, a result of the analysis by the interference analysis unit 25 at a current time is displayed. In the real-time display column, contents of the wireless resource control for interference that is to be executed or is already executed by the wireless resource control unit 26 at the nearest time are displayed. Meanwhile, in the log display field, logs of results of analysis by the interference analysis unit 25 at past times are displayed. In the log display field, logs of the wireless resource control for interference executed by the wireless resource control unit 26 at the past times are displayed. In the example illustrated in FIG. 12, an interference occurrence time, an occurrence frequency band, temporal consecutiveness, spatial consecutiveness, an interference detection spot, whether the wireless resource control has been executed, and contents of the control in a case of having been executed are displayed as display items. The display items may include at least one of these items.

In the image I illustrated in FIG. 12, for convenience of description, a UI that displays the “real-time display” field and the “log display” field at the same time is described above as an example. However, the output control unit 27 may display either one of the “real-time display” field and the “log display” field. A mode of outputting the logs by the output control unit 27 is not limited to the mode of displaying the “log display” field in a form of a table as illustrated in the lower side in FIG. 12. For example, the output control unit 27 may have a mode of: associating, with each other, the data associated with the respective display items included in the table; and storing (accumulating) such associated data as data record in a memory (such as the memory 52 illustrated in FIG. 5); and outputting, in a response to a request by a user or the like managing the wireless communication system 100, the data record stored in the memory, to a screen or a recording medium.

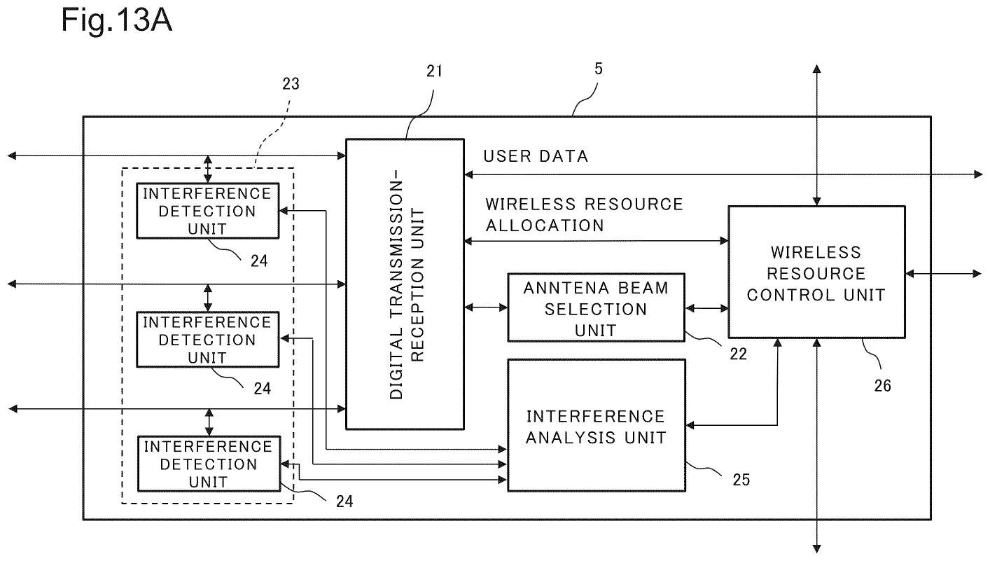

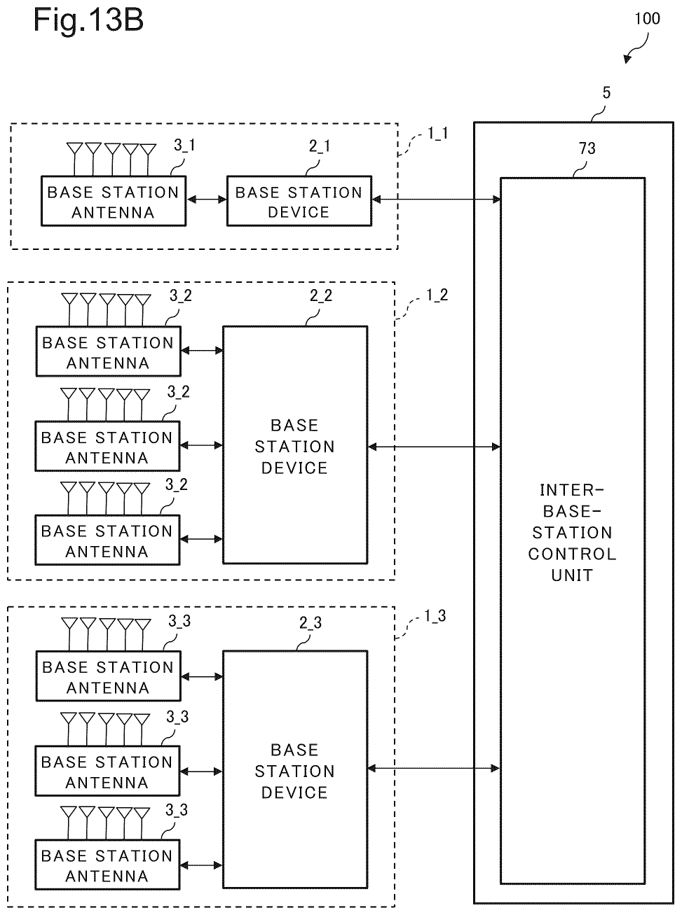

Next, a modified example of the wireless communication system 100 will be described with reference to FIG. 13A and FIG. 13B.

Normally, each of the base station devices 2 includes a radio unit (RU), a distributed unit (DU), and a center unit (CU). Each of the function units (the digital transmission-reception unit 21, the antenna beam selection unit 22, the interference detection unit 23, the interference analysis unit 25, and the wireless resource control unit 26) included in each of the base station device 2 may be mounted in any unit of the RU, the DU, and the CU of the base station device 2.

Some or all function units of these function units may be provided in a control device 5 outside the base station device 2. For example, as illustrated in FIG. 13A, the digital transmission-reception unit 21, the antenna beam selection unit 22, the interference detection unit 23, the interference analysis unit 25, and the wireless resource control unit 26 may be provided in the control device 5. In addition to this, the control device 5 may include the output control unit 27. Alternatively, for example, as illustrated in FIG. 13B, only the inter-base-station control unit 73 in the wireless resource control unit 26 may be provided in the control device 5.

In other words, the wireless communication system 100 may include the control device 5. The control device 5 is constituted by a RAN intelligent controller (RIC), for example. A hardware configuration of a main part of the control device 5 is similar to that described with reference to FIG. 3 to FIG. 5. The control device 5 may be provided in any of the base station devices 2, instead of being provided outside the base station device 2. In this case, the control device 5 may be constituted by at least one of the RU, the DU, and the CU.

Herein, as described above, the allocation control of the wireless resources between or among the wireless base stations 1 is implemented by cooperation of a plurality of the inter-base-station control units 73 (refer to FIG. 10) provided in a plurality of the base station devices 2. Alternatively, the allocation control of the wireless resources between or among the wireless base stations 1 may be implemented by the one inter-base-station control unit 73 (refer to FIG. 13B; not illustrated in FIG. 13A) provided in the control device 5 that can freely communicate with each of a plurality of the base station devices 2. In other words, the allocation control of the wireless resources between or among the wireless base stations 1 may be implemented by the distributed control, or may be implemented by what is called “centralized control”.

Next, advantageous effects of the wireless communication system 100 will be described.

As described above, the interference detection unit 23 detects occurrence of the interference in the wireless communication system 100. The interference analysis unit 25 executes the analysis that is based on a result of detection by the interference detection unit 23 and that includes the estimation of consecutiveness of the interference. The wireless resource control unit 26 executes the wireless resource control (wireless resource control for interference) for reducing influence of the interference, depending on a result of the analysis by the interference analysis unit 25. The consecutiveness includes at least one of the temporal consecutiveness and the spatial consecutiveness.

In this manner, the interference detection unit 23 detects occurrence of the interference in the wireless communication system 100. The interference analysis unit 25 executes the analysis that is based on a result of the detection by the interference detection unit 23 and that includes the estimation of the consecutiveness of the interference. The wireless resource control unit 26 executes the wireless resource control (wireless resource control for interference) for reducing influence of the interference, depending on a result of the analysis by the interference analysis unit 25. Thereby, the wireless resource control unit 26 can execute the wireless resource control for interference, depending on the result of the analysis that includes the estimation of the consecutiveness of the interference. Herein, the consecutiveness includes at least one of the temporal consecutiveness and the spatial consecutiveness. Therefore, executing the wireless resource control for interference, depending on such consecutiveness, can prevent the wireless resource control for interference from being executed for the interference that occurs in a pinpoint manner. Thus, the wireless resource control for interference can be suppressed from being unnecessarily executed, while influence of the interference having the consecutiveness is reduced. As a result, for example, the wireless base stations 1 to which the respective wireless terminals 4 are connected can be prevented from being frequently switched by the execution of the unnecessary wireless resource control for interference.

Specifically, for example, when the interference having the temporal consecutiveness and the spatial consecutiveness occurs, the wireless resource control for interference is executed. Thereby, influence of such interference can be reduced. Meanwhile, when the interference that does not have these pieces of the consecutiveness occurs, the wireless resource control for interference is not executed. Thereby, such control can be suppressed from being unnecessarily executed.

Particularly, in a self-management wireless communication system such as what is called “local 5G”, the interference is likely to occur as described below. Thus, the technique according to the first example embodiment is preferably used.

In other words, in a license system that can be adopted in the self-management wireless communication systems such as the local 5G, an operating company or the like defines an area as a communication target, and a license for a unit of the area is applied and granted. Thus, for example, there is a possibility that the wireless communication system in the self-owned area does not cooperate and synchronize with another local 5G system in an adjacent area. In this case, basically, there is a high probability that a license is granted after it is previously confirmed at the time of granting the license that no radio wave interference mutually occurs. However, there is a possibility that as the operation mutually continues, the wireless communication system in the adjacent area gradually causes the radio wave interference with the wireless communication system in the self-owned area, and performance (a system throughput, throughputs of respective wireless terminals, and the like) of the wireless communication system in the self-owned area is reduced. When a plurality of local 5G systems are operated not only in an adjacent area but also within the self-owned area, there is a possibility that the similar interference occurs between the systems.

Generally, a wireless communication system such as local 5G that uses a high frequency band uses the TDD. Normally, in the TDD, all wireless communication systems operated in the same frequency band use the same TDD configuration, and thereby, up/down (transmission/reception) is completely synchronized. However, in the quasi-synchronous TDD or the like, the operation is allowed with any one of a plurality of TDD configurations in which up/down (transmission/reception) differs in only a part of frames. In the quasi-synchronous TDD, when a plurality of wireless communication systems are operated as described above, frames differing in up/down (transmission/reception) exist between the different systems, thus causing a state in which the radio wave interference is particularly likely to occur.

In regard to this, using the technique according to the first example embodiment causes the wireless resource control for interference to be executed depending on the consecutiveness of the interference, as described above. As a result of this, the wireless resource control for interference can be suppressed from being unnecessarily executed, while influence of the interference is reduced.

The analysis by the interference analysis unit 25 is the prediction based on a result of the estimation of the consecutiveness, and includes the prediction of whether execution of the wireless resource control is necessary. The wireless resource control unit 26 executes the wireless resource control when it is predicted that execution of the wireless resource control is necessary. Thereby, as described above, the wireless resource control for interference can be executed depending on the consecutiveness of the interference.

The interference analysis unit 25 estimates the consecutiveness for each of the predetermined units. The predetermined unit is constituted by at least one of a frequency resource and a TDD slot number. Thereby, for example, the consecutiveness of the interference can be estimated for each of the RBs or for each of TDD slot numbers.

Particularly, for example, estimating the consecutiveness of the interference for each of TDD slot numbers enables a synchronous section and an asynchronous section (refer to FIG. 7A and FIG. 7B) in the quasi-synchronous TDD to be distinguished from each other in the interference analysis processing. In other words, the interference analysis processing that takes, into account, up/down in each of the wireless communication systems (100, 100′) can be implemented.

The interference analysis unit 25 includes at least one of: the interference area estimation unit 62 that estimates the spatial consecutiveness; and an interference period estimation unit 63 that estimates the temporal consecutiveness. Thereby, at least one of the temporal consecutiveness and the spatial consecutiveness of the interference can be estimated.

The interference area estimation unit 62 executes the interpolation processing based on the kriging method, and thereby estimates the spatial consecutiveness. For example, using such interpolation processing can estimate the spatial consecutiveness of the interference in the entire associated area A.

The interference area estimation unit 62 estimates a position and a direction of the interference source (IS), based on beam information associated with each of the interference detection spots (P_1 to P_3), and estimates the spatial consecutiveness, based on the position and the direction of the interference source (IS) (refer to FIG. 9B)). Using the kriging-with-trend method, the regression kriging method, or the like can estimate the spatial consecutiveness with high accuracy.

The wireless resource control (wireless resource control for interference) includes the control of load distribution between or among the wireless base stations 1. Thereby, an accommodation risk due to the interference having the consecutiveness can be prevented from occurring.

The load distribution control includes at least one of: the control of executing the handover; the control of executing carrier aggregation; the control of executing dual connectivity; and the control of allocating network slices.

These pieces of the control can implement the load distribution between or among the wireless base stations 1.

The wireless resource control unit 26 includes the accommodation information update unit 72. The accommodation information update unit 72 updates the accommodation information, based on a result of the analysis by the interference analysis unit 25. The accommodation information is information indicating the accommodable terminal number or the accommodable traffic volume in each of the wireless base stations 1. The wireless resource control unit 26 uses the accommodation information for the load distribution control. Thereby, when the interference having the consecutiveness occurs, the load distribution control can be executed depending on the accommodable terminal number or the accommodable traffic volume.

The interference detection unit 23 extracts a feature value based on a reception level of a received signal at the base station antenna 3 of the associated wireless base station 1, and detects occurrence of the interference by using the feature value. As the feature value, a statistical value of a reception level in a fixed period is used. Using such a feature value can detect occurrence of the interference. Specifically, occurrence of the interference can be detected by the first detection method, the second detection method, or the third detection method described above, for example.

The interference detection unit 23 extracts a feature value based on a reception level of a received signal at the base station antenna 3 of the associated wireless base station 1, and detects occurrence of the interference by using the feature value. As the feature value, a reception level of a reference signal transmitted by the adjacent other wireless base station 1 is used. Using such a feature value can detect occurrence of the interference. Specifically, occurrence of the interference can be detected by the above-described third detection method, for example.

The interference detection unit 23 detects occurrence of the interference by inputting the feature value to the trained model. The trained model is generated by machine learning that uses past feature values. Using such a trained model can detect occurrence of the interference. Specifically, occurrence of the interference can be detected by the first detection method, the second detection method, or the third detection method described above, for example.

The interference detection unit 23 determines presence or absence of the interference for each of TDD slot numbers. Thereby, occurrence of the interference can be detected for each of TDD slot numbers. For example, in the interference detection processing, a synchronous section and an asynchronous section (refer to FIG. 7A and FIG. 7B) in the quasi-synchronous TDD can be distinguished from each other. In other words, the interference detection processing that takes, into account, up/down in each of the wireless communication systems (100, 100′) can be implemented.

The interference detection unit 23 determines presence or absence of the interference for each of the beams in the beam control that uses a plurality of the antenna elements. Thereby, occurrence of the interference can be detected for each of the beams (i.e., for each of the beam directions).

The output control unit 27 executes the control of outputting information (interference analysis information) indicating a result of the analysis by the interference analysis unit 25, and also executes the control of outputting information (wireless resource control information) indicating a content of the wireless resource control that is to be executed or has been executed by the wireless resource control unit 26. Thereby, for example, these pieces of the information can be visually provided (refer to FIG. 12).

The control executed by the output control unit 27 includes: the control of storing, in the recording medium, the information (interference analysis information) indicating a result of the analysis by the interference analysis unit; and the control of storing, in the recording medium, the information (wireless resource control information) indicating a content of the wireless resource control that is to be executed or has been executed by the wireless resource control unit 26. Thereby, these pieces of the information can be accumulated.

The consecutiveness includes both of the temporal consecutiveness and the spatial consecutiveness. The interference analysis unit 25 estimates each of the temporal consecutiveness and the spatial consecutiveness. Estimating both of the temporal consecutiveness and the spatial consecutiveness can prevent unnecessary execution more reliably than an assumed case of estimating either one (e.g., only the temporal consecutiveness) of the temporal consecutiveness and the spatial consecutiveness.

### Second Example Embodiment

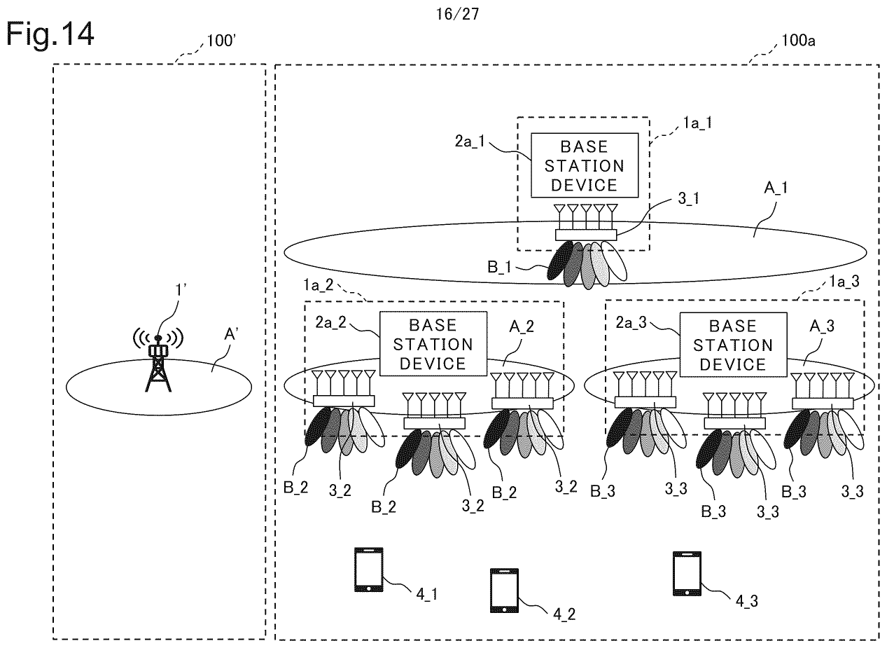

FIG. 14 is an illustration illustrating a main part of a wireless communication system according to a second example embodiment. The wireless communication system according to the second example embodiment will be described with reference to FIG. 14. In FIG. 14, elements similar to those illustrated in FIG. 1 are denoted by the same reference signs.

As illustrated in FIG. 14, the wireless communication system 100a includes one or more wireless base stations 1a. In the example illustrated in FIG. 14, the wireless communication system 100a includes the three wireless base stations 1a_1, 1a_2, and 1a_3. Each of the wireless base stations 1a is constituted by a base station device 2a and the one or more base station antennas 3. In the example illustrated in FIG. 14, the wireless base station 1a_1 is constituted by the base station device 2a_1 and the one base station antenna 3_1. The wireless base station 1a_2 is constituted by the base station device 2a_2 and the three base station antennas 3_2. The wireless base station 1a_3 is constituted by the base station device 2a_3 and the three base station antennas 3_3.

In this manner, the main part of the wireless communication system 100a is configured.

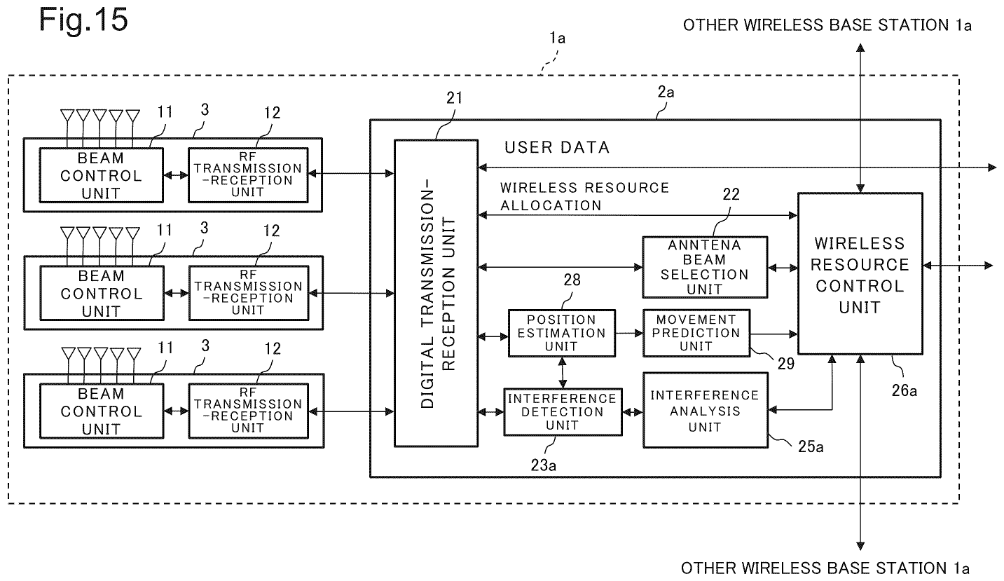

Next, each of the wireless base stations 1a will be described with reference to FIG. 15. In other words, the one wireless base station 1a among the one or more wireless base stations 1a included in the wireless communication system 100a will be described. In FIG. 15, blocks similar to those illustrated in FIG. 2 are denoted by the same reference signs, and the description will be omitted.

As illustrated in FIG. 15, the base station device 2a includes the digital transmission-reception unit 21, the antenna beam selection unit 22, an interference detection unit 23a, an interference analysis unit 25a, and a wireless resource control unit 26a. In addition to this, the base station device 2a includes a position estimation unit 28 and a movement prediction unit 29.

The position estimation unit 28 estimates a position of each of the wireless terminals 4. The position estimation unit 28 outputs information (hereinafter, referred to as “position information”) indicating the estimated position. Hereinafter, the processing executed by the position estimation unit 28 is collectively referred to as “position estimation processing” in some cases.

Specifically, for example, the position estimation unit 28 uses a wireless signal in the wireless communication system 100a, for estimating such a position. In other words, the position estimation unit 28 executes, for each of the wireless terminals 4, distance measurement using a wireless signal associated with each of the beams (each of the beam directions) in each of the base station antennas 3. Thereby, the position estimation unit 28 measures a direction and a distance of each of the wireless terminals 4 by using, as a reference, the installation position of each of the base station antennas 3. Thereby, the position of each of the wireless terminals 4 in the associated area A is estimated.

For example, such distance measurement uses a method of computing a distance by using a propagation time (round trip time, or the like) of a wireless signal. Alternatively, for example, such distance measurement uses a method of computing a distance, based on a propagation model of a radio wave, by using a reception level of a wireless signal. Alternatively, a position of each of the wireless terminals 4 may be estimated, by what is called “three-point positioning”, based on a result of distance measurement using each of a plurality of the base station antennas 3. Data indicating an associated relation between a reception level of a distance-measurement wireless signal at each of the base station antennas and a position of the wireless terminal may be prepared in advance, and a position of each of the wireless terminals 4 is estimated by using such data.

The position estimation unit 28 may estimate a position of each of the wireless terminals 4 in a stepping manner by using these methods. For example, first, the position estimation unit 28 roughly estimates a position of each of the wireless terminals 4 by the distance measurement using each of the beams (each of the beam directions) of each of the base station antennas 3. In other words, the position estimation unit 28 estimates a region that can include such a position. Next, the position estimation unit 28 may estimate, in detail, a position of the wireless terminal 4 in such a region, based on reception levels at s plurality of the base station antennas 3.

The position estimation unit 28 may use different information instead of or in addition to using a wireless signal in the wireless communication system 100a. Specifically, for example, the position estimation unit 28 acquires information indicating a position of each of the wireless terminal 4 measured by a global positioning system (GPS). Alternatively, for example, the position estimation unit 28 acquires information indicating a position of each of the wireless terminals 4 measured by a different sensor (such as an acceleration sensor provided in each of the wireless terminals 4). The position estimation unit 28 may estimate a position of each of the wireless terminals 4 by acquiring these pieces of the information.

The movement prediction unit 29 predicts movement of each of the wireless terminals 4, based on positions estimated by the position estimation unit 28. Specifically, for example, concerning each of the wireless terminals 4, interpolation processing (e.g., linear interpolation) using extrapolation is executed for positions at a plurality of consecutive time points. Thereby, the movement prediction unit 29 predicts a position of each of the wireless terminals 4 at each future time point. In this manner, movement of each of the wireless terminals 4 is predicted. Hereinafter, the processing executed by the movement prediction unit 29 is collectively referred to as “movement prediction processing” in some cases.

The interference detection unit 23a detects occurrence of the interference in the wireless communication system 100a. In other words, the interference detection unit 23a executes the interference detection processing, and outputs the interference detection information. Herein, the interference detection unit 23a detects occurrence of the interference by executing the following fourth detection method instead of or in addition to the first detection method to the third detection method described in the first example embodiment.

### <Fourth Detection Method>

The fourth detection method differs from the first detection method to the third detection method in a used feature value.

In other words, each of the wireless terminals 4 measures a reception level of a synchronization signal or a reference signal from the wireless base station 1a (more specifically, each of the beams of each of the base station antennas 3). Each of the wireless terminals 4 transmits a signal including the measured reception level to the wireless base station 1a. The wireless base station 1a receives and demodulates such a signal. Thereby, the interference detection unit 23a acquires information indicating the reception level (i.e., reception quality) of the received signal at each of the wireless terminals 4. The interference detection unit 23a acquires information indicating the base station antenna 3 associated with such a reception level, and information indicating the beam associated with such a reception level. Further, the interference detection unit 23a acquires information (i.e., position information) indicating a position of each of the wireless terminals 4. The interference detection unit 23a uses these pieces of the information as feature values.

The interference detection unit 23a detects occurrence of the interference by using such feature values, for example, by a method similar to the first detection method or the second detection method. In other words, the interference detection unit 23a detects occurrence of the interference by inputting the feature values to a trained model generated by beforehand unsupervised learning. Alternatively, the interference detection unit 23a detects occurrence of the interference by executing analytical computation by using such feature values. Alternatively, the interference detection unit 23a detects occurrence of the interference by inputting the feature values to a trained model generated by beforehand supervised learning.

When each of the wireless terminals 4 is compatible with beam control similar to that for each of the base station antennas 3, the interference detection processing may be executed for each of beams in such beam control. In other words, the interference detection unit 23a may determine presence or absence of the interference, for each of the beams in such beam control.

The interference analysis unit 25a executes interference analysis processing similar to the interference analysis processing executed by the interference analysis unit 25 according to the first example embodiment. In other words, the interference analysis unit 25a may include an analysis unit division unit 61, an interference area estimation unit 62, an interference period estimation unit 63, and an interference prediction unit 64 (not illustrated in FIG. 15) similar to those in the interference analysis unit 25.

However, the interference detection information output by the interference detection unit 23a is used in estimation of each of the temporal consecutiveness and the spatial consecutiveness. In other words, in estimation of the spatial consecutiveness in the interference analysis unit 25, an index value associated with each of the base station antennas 3 is computed, and the computed index value is plotted in the grid associated with the installation position of such a base station antenna 3 (refer to FIG. 9A). In contrast to this, in estimation of the spatial consecutiveness in the interference analysis unit 25a, an index value associated with each of the wireless terminals 4 is computed, and the computed index value is plotted in the grid associated with a position (i.e., a position indicated by the position information) of such a wireless terminal 4. In other words, instead of the spot associated with the installation position of each of the base station antennas 3, a spot associated with the position of each of the wireless terminals 4 can be an interference detection spot. When the interference detection processing is executed for each of beams in each of the wireless terminals 4, a position and a direction of an interference source may be estimated based on such a beam direction, similarly to the example described with reference to FIG. 9B.

The wireless resource control unit 26a executes wireless resource control for interference similar to the wireless resource control for interference executed by the wireless resource control unit 26 according to the first example embodiment. In other words, the wireless resource control for interference is executed depending on a result of the analysis by the interference analysis unit 25a. The wireless resource control unit 26a may include the intra-base-station control unit 71, the accommodation information update unit 72, and the inter-base-station control unit 73 (not illustrated in FIG. 15) similar to those in the wireless resource control unit 26.

However, the wireless resource control unit 26a differs from the wireless resource control unit 26 in that the wireless resource control unit 26a can execute the wireless resource control for interference based on a result of the prediction by the movement prediction unit 29.

For example, as described in the first example embodiment, the wireless resource control for interference includes the load distribution control between or among the wireless base stations 1a. The load distribution control includes control of executing the handover. At this time, based on a result of the prediction by the movement prediction unit 29, the wireless resource control unit 26a preferentially sets, as a target of the handover in the wireless resource control for interference, the wireless terminal 4 having a high possibility of needing a normal handover due to movement. Then, the wireless resource control unit 26a makes control concerning such a wireless terminal 4 in such a way as to execute the handover by the wireless resource control for interference, prior to the normal handover due to the movement.

In this manner, the main part of the wireless base station 1a is configured.

A hardware configuration of the main part of the base station device 2a is similar to that described in the first example embodiment with reference to FIG. 3 to FIG. 5. Thus, the detailed description is omitted. In other words, the function of each unit of the base station device 2a may be implemented by the processor 51 and the memory 52, or may be implemented by the processing circuit 53.

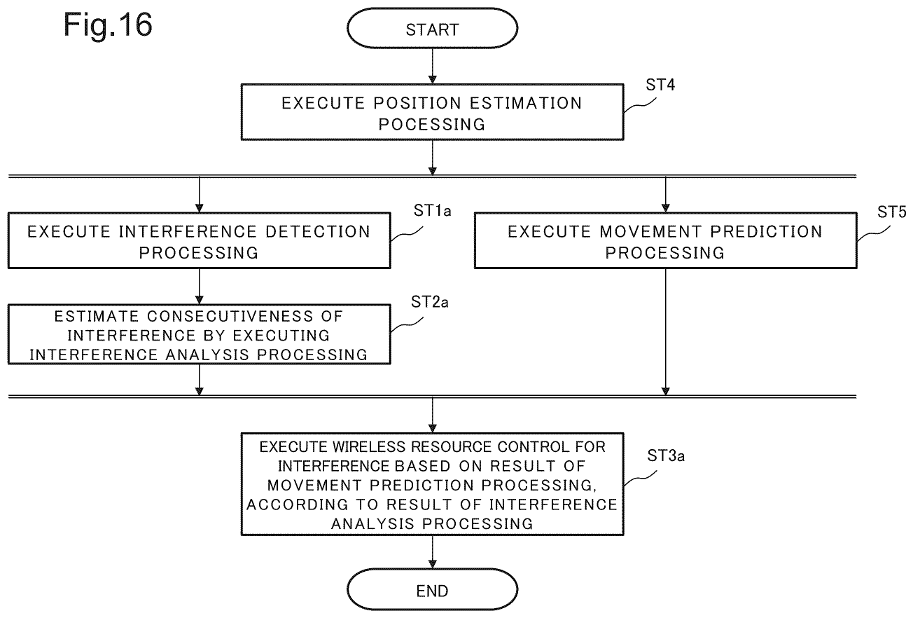

Next, with reference to a flowchart illustrated in FIG. 16, description will be made on operation of the base station device 2a, mainly on operation of the interference detection unit 23a, the interference analysis unit 25a, the wireless resource control unit 26a, the position estimation unit 28, and the movement prediction unit 29. First, the position estimation unit 28 executes the position estimation processing (step ST4).

Next, the interference detection unit 23a executes the interference detection processing (step ST1a). As described above, the position information at the step ST4 is used for the interference detection processing at the step ST1a. Next, the interference analysis unit 25a executes the interference analysis processing (step ST2a). Thereby, the consecutiveness of the interference detected by the interference detection processing is estimated.

Meanwhile, the movement prediction unit 29 executes the movement prediction processing (step ST5). As described above, the position information at the step ST4 is used for the movement prediction processing.

Next, the wireless resource control unit 26a executes the wireless resource control for interference, depending on a result of the interference analysis processing (step ST3a). As described above, the wireless resource control for interference includes the load distribution control (e.g., the handover) based on a result of the movement prediction processing.

Next, a modified example of the base station device 2a will be described.

Selection by the antenna beam selection unit 22 may be executed based on a result of estimation by the position estimation unit 28 and a result of prediction by the movement prediction unit 29. For example, the antenna beam selection unit 22 selects, for each of the wireless terminals 4, based on a position of such a wireless terminal 4 after a predetermined time, the base station antenna 3 or the beam to be used for communication with such a wireless terminal 4.

Next, another modified example of the base station device 2a will be described.

The base station device 2a may include the output control unit 27, similarly to the example described with reference to FIG. 11 and FIG. 12 in the first example embodiment. Thereby, the information (i.e., the interference analysis information) indicating a result of the analysis by the interference analysis unit 25a is output to an outside. The information (i.e., the wireless resource control information) concerning the wireless resource control for interference that is to be executed or has been executed by the wireless resource control unit 26a is output to an outside. Specifically, for example, the image I including these pieces of the information is displayed (refer to FIG. 12).

Next, a modified example of the wireless communication system 100a will be described.

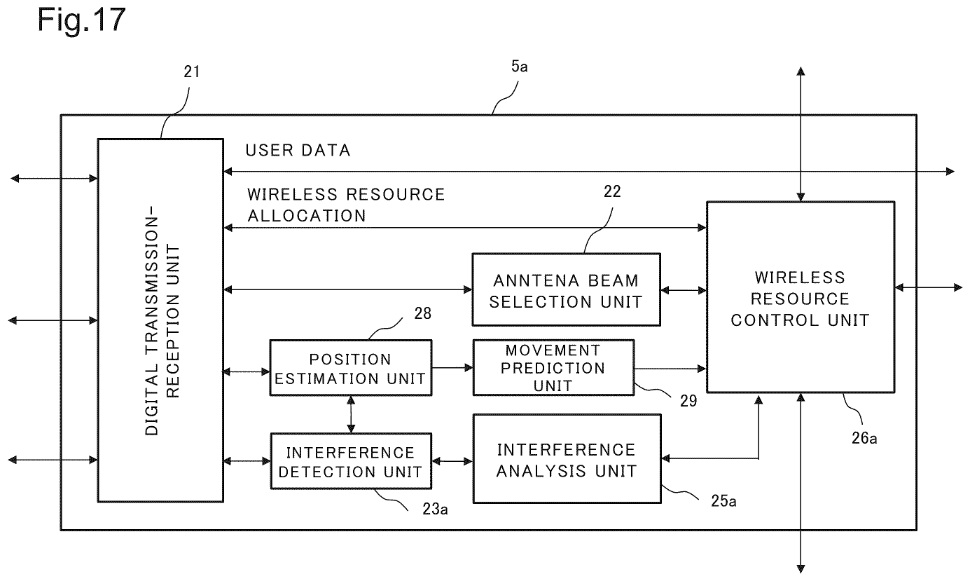

The wireless communication system 100a may include a control device 5a similar to the control device 5. For example, the control device 5a may include all or a part of the digital transmission-reception unit 21, the antenna beam selection unit 22, the interference detection unit 23a, the interference analysis unit 25a, the wireless resource control unit 26a, the position estimation unit 28, and the movement prediction unit 29 (refer to FIG. 17). In addition to this, the control device 5a may include the output control unit 27.

Next, advantageous effects of the wireless communication system 100a will be described.

The wireless communication system 100a achieves advantageous effects similar to those described in the first example embodiment. In addition to this, the wireless communication system 100a achieves the following advantageous effects.

In other words, the movement prediction unit 29 predicts movement of the wireless terminal 4 in the wireless communication system 100a. The wireless resource control unit 26a executes the load distribution control based on a result of the prediction by the movement prediction unit 29. Thereby, for example, the handover in the wireless resource control for interference can be efficiently executed.

The position estimation unit 28 estimates a position of the wireless terminal 4 in the wireless communication system 100a. The interference detection unit 23a extracts feature values based on a position of the wireless terminal 4 and a reception level of a received signal at the wireless terminal 4, and detects occurrence of the interference by using the feature values. Using such feature values enables detection of occurrence of the interference. Specifically, for example, occurrence of the interference can be detected by the above-described fourth detection method. In this case, there is also an advantage that detailed interference detection is enabled depending on the number of the wireless terminals 4 in the area and position changes of the wireless terminals 4.

### Third Example Embodiment

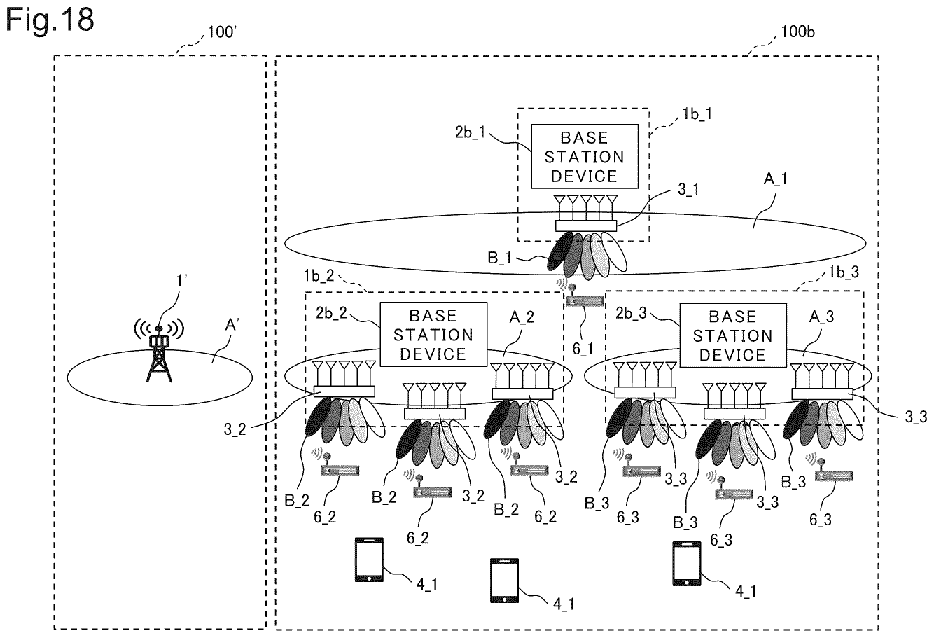

FIG. 18 is an illustration illustrating a main part of a wireless communication system according to a third example embodiment. With reference to FIG. 18, the wireless communication system according to the third example embodiment will be described. In FIG. 18, elements similar to those illustrated in FIG. 1 are denoted by the same reference signs, and the description will be omitted.

As illustrated in FIG. 18, the wireless communication system 100b includes one or more wireless base stations 1b. In an example illustrated in FIG. 18, the wireless communication system 100b includes the three wireless base stations 1b_1, 1b_2, and 1b_3. Each of the wireless base stations 1b is constituted by a base station device 2b and the one or more base station antennas 3. In the example illustrated in FIG. 18, the wireless base station 1b_1 is constituted by the base station device 2b_1 and the one base station antenna 3_1. The wireless base station 1b_2 is constituted by the base station device 2b_2 and the three base station antennas 3_2. The wireless base station 1b_3 is constituted by the base station device 2b_3 and the three base station antennas 3_3.

In the wireless communication system 100b, one or more radio wave sensors 6 are provided in the area A associated with each of the wireless base stations 1b. In the example illustrated in FIG. 18, the wireless communication system 100b includes the one radio wave sensor 6_1 associated with the one base station antenna 3_1. The wireless communication system 100b includes the three radio wave sensors 6_2 associated with the three base station antennas 3_2. The wireless communication system 100b includes the three radio wave sensors 6_3 associated with the three base station antennas 3_3. Each of the base station devices 2 can freely communicate with each of the associated radio wave sensors 6 by wired communication or by wireless communication using the associated base station antenna 3. Although the numbers of the base station antennas 3 and the radio wave sensors 6 match each other in the example illustrated in FIG. 18, there is particularly no problem even when these numbers do not match each other.

In this manner, the main part of the wireless communication system 100b is configured.

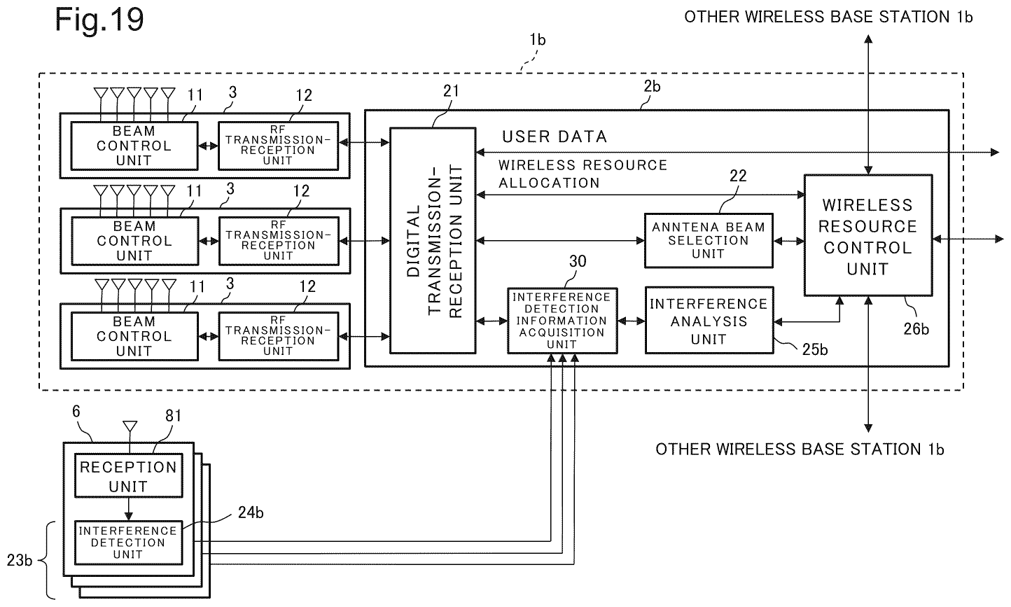

Next, each of the wireless base stations 1b will be described with reference to FIG. 19. In other words, the one wireless base station 1b among the one or more wireless base stations 1b included in the wireless communication system 100b will be described. In FIG. 19, blocks similar to those illustrated in FIG. 2 are denoted by the same reference signs, and the description will be omitted.

As illustrated in FIG. 19, the base station device 2b includes the digital transmission-reception unit 21, the antenna beam selection unit 22, an interference analysis unit 25b, and a wireless resource control unit 26b. In addition to this, the base station device 2b includes an interference detection information acquisition unit 30. Meanwhile, each of the one or more associated radio wave sensors 6 includes a reception unit 81 and an interference detection unit 24b. In other words, the one or more radio wave sensors 6 are each provided with the one or more reception units 81, and are each provided with the one or more interference detection units 24b. These interference detection units 24b constitute an interference detection unit 23b.

Each of the radio wave sensors 6 is used for detecting the interference at an installed position. In other words, in each radio wave sensor 6, the interference detection unit 24b executes the interference detection processing by using a signal received by the reception unit 81. In other words, the interference detection unit 24b extracts a predetermined feature value (e.g., a feature value based on a reception level) from the received signal. The interference detection unit 24b detects occurrence of the interference by a detection method similar to the first detection method, the second detection method, or the third detection method described in the first example embodiment, by using the extracted feature value. Alternatively, the interference detection unit 24b detects occurrence of the interference by a detection method similar to the fourth detection method described in the second example embodiment, by using the extracted feature value. Alternatively, the interference detection unit 24b detects occurrence of the interference by executing a combination of two or more of these detection methods. The interference detection unit 24b outputs the interference detection information.

The interference detection information acquisition unit 30 acquires the interference detection information output by each of the interference detection units 24b. As described above, the interference detection information may be acquired by wired communication, or may be acquired by wireless communication.

The interference analysis unit 25b executes interference analysis processing similar to the interference analysis processing executed by the interference analysis unit 25 according to the first example embodiment. In other words, the interference analysis unit 25b may include the analysis unit division unit 61, the interference area estimation unit 62, the interference period estimation unit 63, and the interference prediction unit 64 (not illustrated in FIG. 19) similar to those in the interference analysis unit 25.

However, the interference detection information acquired by the interference detection information acquisition unit 30 is used in estimation of each of the temporal consecutiveness and the spatial consecutiveness. In other words, in estimation of the spatial consecutiveness in the interference analysis unit 25, an index value associated with each of the base station antennas 3 is computed, and the computed index value is plotted in the grid associated with the position of such a base station antenna 3 (refer to FIG. 9A). In contrast to this, in estimation of the spatial consecutiveness in the interference analysis unit 25b, an index value associated with each of the radio wave sensors 6 is computed, and the computed index value is plotted in the grid associated with the position of such a radio wave sensor 6.

The wireless resource control unit 26b executes wireless resource control for interference similar to the wireless resource control for interference executed by the wireless resource control unit 26 according to the first example embodiment. In other words, the wireless resource control for interference is executed depending on a result of the analysis by the interference analysis unit 25b. The wireless resource control unit 26b may include the intra-base-station control unit 71, the accommodation information update unit 72, and the inter-base-station control unit 73 (not illustrated in FIG. 19) similar to those in the wireless resource control unit 26.

In this manner, the main part of the wireless base station 1b is configured.

A hardware configuration of the main part of the base station device 2b is similar to that described in the first example embodiment with reference to FIG. 3 to FIG. 5. Thus, the detailed description is omitted. In other words, the function of each unit of the base station device 2b may be implemented by the processor 51 and the memory 52, or may be implemented by the processing circuit 53.

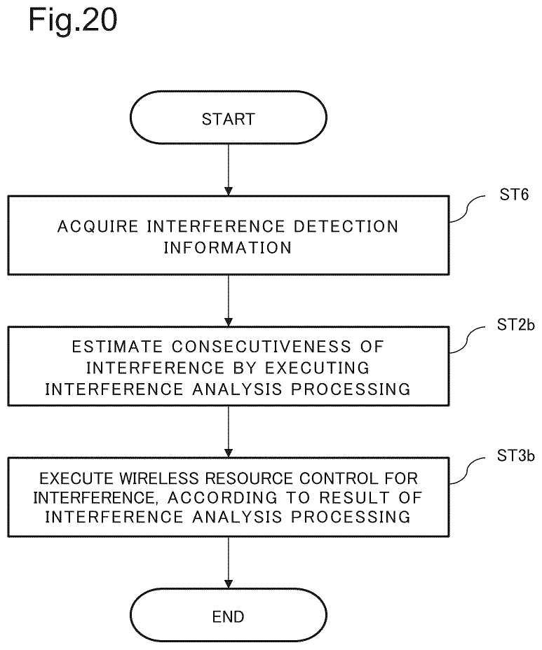

Next, with reference to a flowchart illustrated in FIG. 20, description will be made on operation of the base station device 2b, mainly on operation of the interference detection information acquisition unit 30, the interference analysis unit 25b, and the wireless resource control unit 26b.

First, the interference detection information acquisition unit 30 acquires the interference detection information (step ST6). Next, the interference analysis unit 25b executes the interference analysis processing (step ST2b). Next, the wireless resource control unit 26b executes the wireless resource control for interference, depending on a result of the interference analysis processing (step ST3b).

Next, a modified example of the base station device 2b will be described.

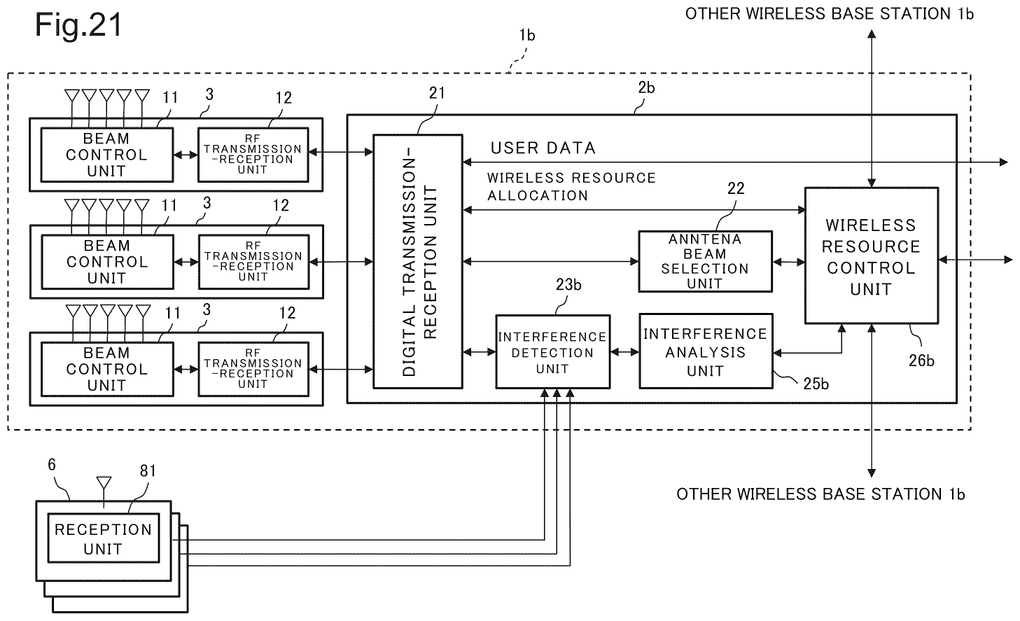

As illustrated in FIG. 21, the base station device 2b may include the interference detection unit 23b, instead of the interference detection information acquisition unit 30. In other words, in this case, each of the radio wave sensors 6 transmits a signal received by the reception unit 81, to the wireless base station 1b. The transmitted signal is received by the associated interference detection unit 24b (not illustrated in FIG. 21) in the interference detection unit 23b. The interference detection processing is executed by using the received signal.

Next, another modified example of the base station device 2b will be described.

The base station device 2b may include the output control unit 27, similarly to the example described in the first example embodiment with reference to FIG. 11 and FIG. 12. Thereby, the information (i.e., the interference analysis information) indicating a result of the analysis by the interference analysis unit 25b is output to an outside. The information (i.e., the wireless resource control information) concerning the wireless resource control for interference that is to be executed or has been executed by the wireless resource control unit 26b is output to an outside. For example, the image I indicating these pieces of the information is displayed (refer to FIG. 12).

Next, a modified example of the wireless communication system 100b will be described.

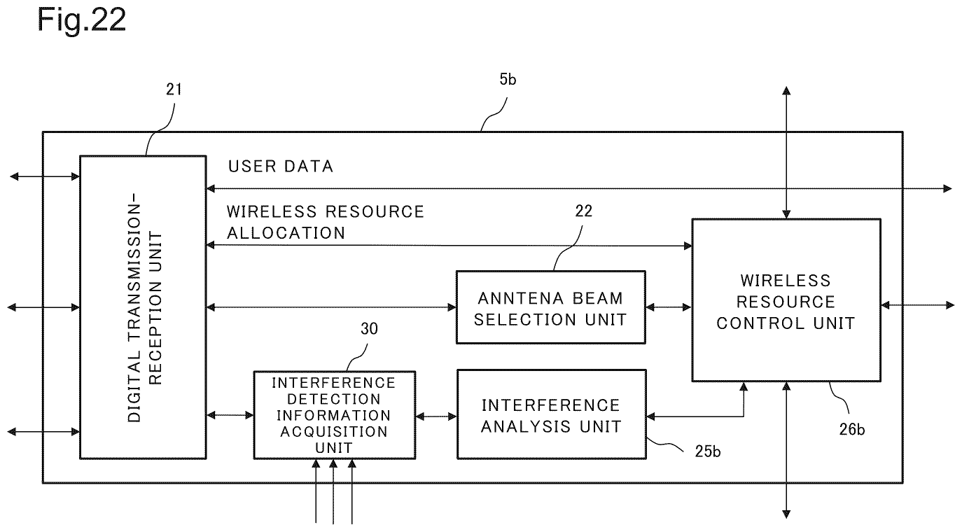

The wireless communication system 100b may include a control device 5b similar to the control device 5. For example, the control device 5b includes the digital transmission-reception unit 21, the antenna beam selection unit 22, the interference analysis unit 25b, the wireless resource control unit 26b, and the interference detection information acquisition unit 30 (refer to FIG. 22). In addition to this, the control device 5b may include the output control unit 27. The control device 5b may include the interference detection unit 23b, instead of the interference detection information acquisition unit 30.

Next, advantageous effects of the wireless communication system 100b will be described.

The wireless communication system 100b achieves advantageous effects similar to those described in the first example embodiment. In addition to this, the wireless communication system 100b achieves the following advantageous effect.

In other words, the wireless communication system 100b includes the radio wave sensor 6. The interference detection unit 23b extracts a feature value based on a reception level of a received signal at the radio wave sensor 6, and detects occurrence of the interference by using the feature value. Using such a feature value enables detection of occurrence of the interference. [Fourth Example Embodiment]

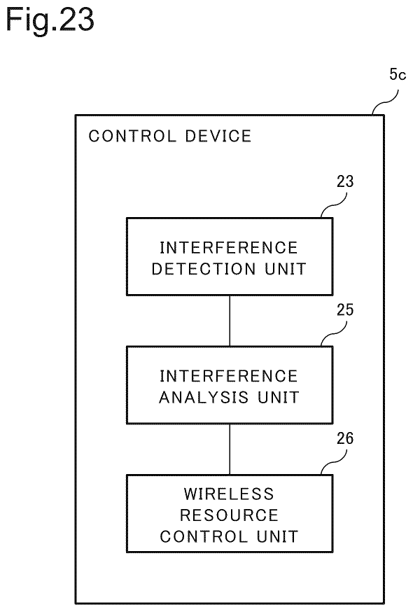

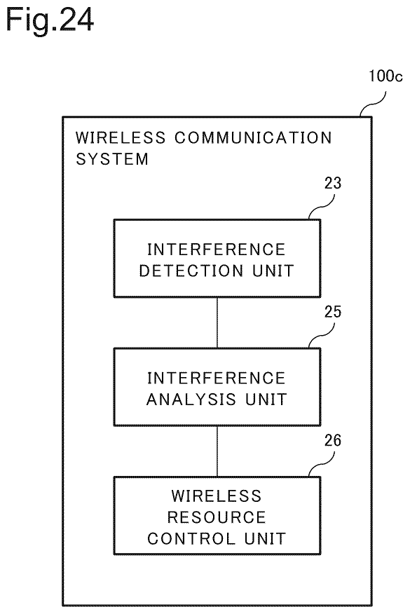

FIG. 23 is a block diagram illustrating a main part of a control device according to a fourth example embodiment. The control device according to the fourth example embodiment will be described with reference to FIG. 23. FIG. 24 is a block diagram illustrating a main part of a wireless communication system according to the fourth example embodiment. The wireless communication system according to the fourth example embodiment will be described with reference to FIG. 24. In each of FIG. 23 and FIG. 24, blocks similar to those illustrated in FIG. 2 are denoted by the same reference signs, and the description is omitted.

Herein, the wireless communication system according to each of the above-described first to third example embodiments is one example of the wireless communication system according to the fourth example embodiment. The control device according to each of the above-described first to third example embodiments is one example of the control device according to the fourth example embodiment.

As illustrated in FIG. 23, the control device 5c includes the interference detection unit 23, the interference analysis unit 25, and the wireless resource control unit 26. In other words, the interference detection unit 23, the interference analysis unit 25, and the wireless resource control unit 26 constitute the main part of the control device 5c.

As illustrated in FIG. 24, the wireless communication system 100c includes the interference detection unit 23, the interference analysis unit 25, and the wireless resource control unit 26. In other words, the interference detection unit 23, the interference analysis unit 25, and the wireless resource control unit 26 constitute the main part of the wireless communication system 100c.

Using the control device 5c enables advantageous effects similar to those described in the first example embodiment to be achieved as follows. Using the wireless communication system 100c enables advantageous effects similar to those described in the first example embodiment to be achieved as follows.

In other words, the interference detection unit 23 detects occurrence of the interference in the wireless communication system 100c (not illustrated in FIG. 23). The interference analysis unit 25 executes the analysis that is based on a result of the detection by the interference detection unit 23 and that includes estimation of the consecutiveness of the interference. Depending on a result of the analysis by the interference analysis unit 25, the wireless resource control unit 26 executes the wireless resource control (wireless resource control for interference) for reducing influence of the interference. The consecutiveness includes at least one of the temporal consecutiveness and the spatial consecutiveness. Executing the wireless resource control for interference, depending on the consecutiveness of the interference, can suppress the wireless resource control for interference from being unnecessarily executed, and meanwhile, can reduce influence of the interference.

The control device 5c may include the interference detection unit 23a, the interference analysis unit 25a, and the wireless resource control unit 26a, instead of the interference detection unit 23, the interference analysis unit 25, and the wireless resource control unit 26. Alternatively, the control device 5c may include the interference detection unit 23b, the interference analysis unit 25b, and the wireless resource control unit 26b, instead of the interference detection unit 23, the interference analysis unit 25, and the wireless resource control unit 26.

The wireless communication system 100c may include the interference detection unit 23a, the interference analysis unit 25a, and the wireless resource control unit 26a, instead of the interference detection unit 23, the interference analysis unit 25, and the wireless resource control unit 26. Alternatively, the wireless communication system 100c may include the interference detection unit 23b, the interference analysis unit 25b, and the wireless resource control unit 26b, instead of the interference detection unit 23, the interference analysis unit 25, and the wireless resource control unit 26.

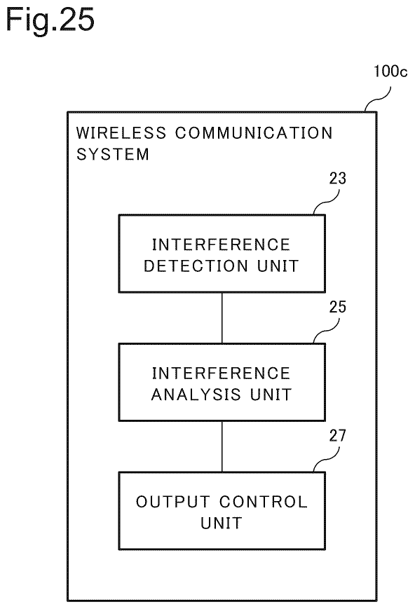

The wireless communication system 100c may include the output control unit 27 (refer to FIG. 25), instead of the wireless resource control unit 26, the wireless resource control unit 26a, or the wireless resource control unit 26b. The output control unit 27 outputs the information (i.e., the interference analysis information) indicating a result of the analysis by the interference analysis unit 25, the interference analysis unit 25a, or the interference analysis unit 25b. In this case, for example, another system (not illustrated) executes the wireless resource control for interference by using the output interference analysis information. Even in this case, an advantageous effect that unnecessary execution of such control can be suppressed is achieved.

The output control unit 27 executes the control of outputting, instead of or in addition to the interference analysis information, the information (i.e., the wireless resource control information) indicating contents of the wireless resource control for interference that is to be executed or has been executed. These pieces of the information may be output as data by using API or the like, may be stored as such data in the recording medium, or may be output (displayed or provided) as an image by using a UI.

For example, the UI in this case may include at least one of an image similar to the real-time display field in the example illustrated in FIG. 12 and an image similar to the log display field in the example illustrated in FIG. 12. The data stored in the recording medium in this case may include data associated with a part or all of these display items (i.e., logs).

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

A part or all of the above-described example embodiments can be described also as in the following Supplementary Notes, but there is no limitation to the following.

### [Supplementary Notes]

### [Supplementary Note 1]

A wireless communication system including one or more wireless base stations, the wireless communication system including:
an interference detection means for detecting occurrence of interference in the wireless communication system;
an interference analysis means for executing analysis that is based on a result of detection by the interference detection means and includes estimation of consecutiveness of the interference; and
a wireless resource control means for, according to a result of analysis by the interference analysis means, executing wireless resource control for reducing influence of the interference, wherein
the consecutiveness includes at least one of temporal consecutiveness and spatial consecutiveness.

### [Supplementary Note 2]

The wireless communication system according to the Supplementary Note 1, wherein
the analysis by the interference analysis means is prediction based on a result of estimation of the consecutiveness, and includes prediction of whether execution of the wireless resource control is necessary, and,
when it is predicted that execution of the wireless resource control is necessary, the wireless resource control means executes the wireless resource control.

### [Supplementary Note 3]

The wireless communication system according to the Supplementary Note 1 or 2, wherein
the interference analysis means estimates the consecutiveness for each predetermined unit, and
the predetermined unit is constituted of at least one of a frequency resource and a TDD slot number.

### [Supplementary Note 4]

The wireless communication system according to any one of the Supplementary Notes 1 to 3, wherein
the interference analysis means includes at least one of an interference area estimation means for estimating the spatial consecutiveness, and an interference period estimation means for estimating the temporal consecutiveness.

### [Supplementary Note 5]

The wireless communication system according to the Supplementary Note 4, wherein
the interference area estimation means estimates the spatial consecutiveness by executing interpolation processing based on a kriging method.

### [Supplementary Note 6]

The wireless communication system according to the Supplementary Note 4 or 5, wherein
the interference area estimation means estimates a position and a direction of an interference source, based on beam information associated with each interference detection spot, and estimates the spatial consecutiveness, based on the position and the direction of the interference source.

### [Supplementary Note 7]

The wireless communication system according to any one of the Supplementary Notes 1 to 6, wherein
the wireless resource control includes load distribution control among the wireless base stations.

### [Supplementary Note 8]

The wireless communication system according to the Supplementary Note 7, wherein
the load distribution control includes at least one of control of executing handover, control of executing carrier aggregation, control of executing dual connectivity, and control of allocating a network slice.

### [Supplementary Note 9]

The wireless communication system according to the Supplementary Note 7 or 8, wherein
the wireless resource control means includes an accommodation information update means for, based on a result of analysis by the interference analysis means, updating accommodation information indicating an accommodable terminal number or an accommodable traffic volume in the wireless base station, and
the wireless resource control means uses the accommodation information for the load distribution control.

### [Supplementary Note 10]

The wireless communication system according to any one of the Supplementary Notes 7 to 9, further including:
a movement prediction means for predicting movement of a wireless terminal in the wireless communication system, wherein
the wireless resource control means executes the load distribution control based on a result of prediction by the movement prediction means.

### [Supplementary Note 11]

The wireless communication system according to any one of the Supplementary Notes 1 to 10, wherein
the interference detection means extracts a feature value based on a reception level of a received signal at a base station antenna of a wireless base station, among the wireless base stations, including the interference detection means, and detects occurrence of the interference by using the feature value, and
a statistical value of the reception level in a fixed period is used as the feature value.

### [Supplementary Note 12]

The wireless communication system according to any one of the Supplementary Notes 1 to 11, wherein
the interference detection means extracts a feature value based on a reception level of a received signal at a base station antenna of a wireless base station, among the wireless base stations, including the interference detection means, and detects occurrence of the interference by using the feature value, and
the reception level of a reference signal transmitted by an adjacent other wireless base station among the wireless base stations is used as the feature value.

### [Supplementary Note 13]

The wireless communication system according to any one of the Supplementary Notes 1 to 10, further including
a position estimation means for estimating a position of a wireless terminal in the wireless communication system, wherein
the interference detection means extracts a feature value based on the position of the wireless terminal and a reception level of a received signal at the wireless terminal, and detects occurrence of the interference by using the feature value.

### [Supplementary Note 14]

The wireless communication system according to any one of the Supplementary Notes 1 to 10, wherein
the wireless communication system includes a radio wave sensor, and
the interference detection means extracts a feature value based on a reception level of a received signal at the radio wave sensor, and detects occurrence of the interference by using the feature value.

### [Supplementary Note 15]

The wireless communication system according to any one of the Supplementary Notes 11 to 14, wherein
the interference detection means inputs the feature value to a trained model and thereby detects occurrence of the interference, and
the trained model is generated by machine learning using the feature value in a past.

### [Supplementary Note 16]

The wireless communication system according to any one of the Supplementary Notes 11 to 15, wherein
the interference detection means determines presence or absence of the interference for each TDD slot number.

### [Supplementary Note 17]

The wireless communication system according to any one of the Supplementary Notes 11 to 16, wherein
the interference detection means determines presence or absence of the interference for each beam in beam control using a plurality of antenna elements.

### [Supplementary Note 18]

The wireless communication system according to any one of the Supplementary Notes 1 to 17, further including:
an output control means for executing control of outputting information indicating a result of analysis by the interference analysis means and information indicating a content of the wireless resource control that is to be executed or has been executed by the wireless resource control means.

### [Supplementary Note 19]

The wireless communication system according to the Supplementary Note 18, wherein
the control to be executed by the output control means includes control of storing, in a recording medium, information indicating a result of analysis by the interference analysis means and information indicating a content of the wireless resource control that is to be executed or has been executed by the wireless resource control means.

### [Supplementary Note 20]

The wireless communication system according to any one of the Supplementary Notes 1 to 19, wherein
the consecutiveness includes both of the temporal consecutiveness and the spatial consecutiveness, and
the interference analysis means estimates each of the temporal consecutiveness and the spatial consecutiveness.

### [Supplementary Note 21]

A control device for a wireless communication system including one or more wireless base stations, the control device including:
an interference detection means for detecting occurrence of interference in the wireless communication system;
an interference analysis means for executing analysis that is based on a result of detection by the interference detection means and includes estimation of consecutiveness of the interference; and
a wireless resource control means for, according to a result of analysis by the interference analysis means, executing wireless resource control for reducing influence of the interference, wherein
the consecutiveness includes at least one of temporal consecutiveness and spatial consecutiveness.

### [Supplementary Note 22]

A control method for a wireless communication system including one or more wireless base stations, the control method including:
detecting, by an interference detection means, occurrence of interference in the wireless communication system;
executing, by an interference analysis means, analysis that is based on a result of detection by the interference detection means and includes estimation of consecutiveness of the interference; and
executing, by a wireless resource control means, according to a result of analysis by the interference analysis means, wireless resource control for reducing influence of the interference, wherein
the consecutiveness includes at least one of temporal consecutiveness and spatial consecutiveness.

### [Supplementary Note 23]

A program for causing a computer for a wireless communication system including one or more wireless base stations to function as:
an interference detection means for detecting occurrence of interference in the wireless communication system;
an interference analysis means for executing analysis that is based on a result of detection by the interference detection means and includes estimation of consecutiveness of the interference; and
a wireless resource control means for, according to a result of analysis by the interference analysis means, executing wireless resource control for reducing influence of the interference, wherein
the consecutiveness includes at least one of temporal consecutiveness and spatial consecutiveness.

### [Supplementary Note 24]

A recording medium recording the program according to the Supplementary Note 23.

### [Supplementary Note 25]

A wireless communication system including one or more wireless base stations, the wireless communication system including:
an interference detection means for detecting occurrence of interference in the wireless communication system;
an interference analysis means for executing analysis that is based on a result of detection by the interference detection means and includes estimation of consecutiveness of the interference; and
an output control means for executing control of at least one of storing in a recording medium and outputting to a user interface, concerning at least one of information indicating a result of analysis by the interference analysis means and information indicating a content of wireless resource control that is to be executed or has been executed, according to a result of analysis by the interference analysis means, for reducing influence of the interference, wherein
the consecutiveness includes at least one of temporal consecutiveness and spatial consecutiveness.

This application is based upon and claims the benefit of priority from Japanese patent application No. 2021-110480, filed on Jul. 2, 2020, the disclosure of which is incorporated herein in its entirety by reference.

### REFERENCE SIGNS LIST

1, 1a, 1b Wireless base station
2, 2a, 2b Base station device
3 Base station antenna
4 Wireless terminal
5, 5a, 5b, 5c Control device
6 Radio wave sensor
11 Beam control unit
12 RF transmission-reception unit
21 Digital transmission-reception unit
22 Antenna beam selection unit
23, 23a, 23b Interference detection unit
24, 24b Interference detection unit
25, 25a, 25b Interference analysis unit
26, 26a, 26b Wireless resource control unit
27 Output control unit
28 Position estimation unit
29 Movement prediction unit
30 Interference detection information acquisition unit
41 Computer
51 Processor
52 Memory
53 Processing circuit
61 Analysis unit division unit
62 Interference area estimation unit
63 Interference period estimation unit
64 Interference prediction unit
71 Intra-base-station control unit
72 Accommodation information update unit
73 Inter-base-station control unit
81 Reception unit
100, 100a, 100b, 100c Wireless communication system

What is claimed is:

1. A wireless base station comprising:
at least one memory configured to store instructions; and at least one processor configured to execute the instructions to
detect occurrence of interference at the wireless base station,
execute interference analysis that is based on a result of detection by the at least one processor and includes estimation of consecutiveness of the interference, and
execute, according to a result of the analysis by the at least one processor, wireless resource control for reducing influence of the interference, wherein
the consecutiveness includes at least one of temporal consecutiveness and spatial consecutiveness.

2. The wireless base station according to claim 1, wherein
the analysis by the at least one processor is prediction based on a result of estimation of the consecutiveness, and includes prediction of whether execution of the wireless resource control is necessary, and,
when it is predicted that execution of the wireless resource control is necessary, the at least one processor executes the wireless resource control.

3. The wireless base station according to claim 1, wherein
the at least one processor estimates the consecutiveness for each predetermined unit, and
the predetermined unit is constituted of at least one of a frequency resource and a TDD slot number.

4. The wireless base station according to claim 1, wherein
the at least one processor estimates at least one of the spatial consecutiveness, and the temporal consecutiveness.

5. The wireless base station according to claim 4, wherein
the at least one processor estimates the spatial consecutiveness by executing interpolation and extrapolation processing based on a kriging method.

6. The wireless base station according to claim 4, wherein
the at least one processor estimates a position and a direction of an interference source, based on beam information associated with each interference detection spot, and estimates the spatial consecutiveness, based on the position and the direction of the interference source.

7. The wireless base station according to claim 1, wherein
the wireless resource control includes load distribution control among the wireless base stations.

8. The wireless base station according to claim 7, wherein
the load distribution control includes at least one of control of executing handover, control of executing carrier aggregation, control of executing dual connectivity, and control of allocating a network slice.

9. The wireless base station according to claim 7, wherein
the at least one processor, based on a result of the interference analysis, updates accommodation information indicating an accommodable terminal number or an accommodable traffic volume in the wireless base station, and
the at least one processor uses the accommodation information for the load distribution control.

10. The wireless base station according to claim 7, wherein further comprising:
the at least one processor predicts movement of a wireless terminal in a wireless communication system, wherein
the at least one processor executes the load distribution control based on a result of prediction of movement of the wireless terminal.

11. The wireless base station according to claim 1, wherein
the at least one processor extracts a feature value based on a reception level of a received signal at a base station antenna of the wireless base station and detects occurrence of the interference by using the feature value, and
a statistical value of the reception level in a fixed period is used as the feature value.

12. The wireless base station according to claim 1, wherein
the at least one processor extracts a feature value based on a reception level of a received signal at a base station antenna of the wireless base station and detects occurrence of the interference by using the feature value, and
the reception level of a reference signal transmitted by an adjacent other wireless base station is used as the feature value.

13. The wireless base station according to claim 1, wherein
the at least one processor estimates a position of other wireless terminals in a wireless communication system, wherein
the at least one processor extracts a feature value based on the position of the other wireless terminals and a reception level of a received signal at the other wireless terminals, and detects occurrence of the interference by using the feature value.

14. The wireless base station according to claim 1, wherein
the wireless base station includes a radio wave sensor, and
the at least one processor extracts a feature value based on a reception level of a received signal at the radio wave sensor, and detects occurrence of the interference by using the feature value.

15. The wireless base station according to claim 11, wherein
the at least one processor inputs the feature value to a trained model and thereby detects occurrence of the interference, and
the trained model is generated by machine learning using the feature value in a past.

16. The wireless base station according to claim 11, wherein
the at least one processor determines presence or absence of the interference for each TDD slot number.

17. The wireless base station according to claim 11, wherein
the at least one processor determines presence or absence of the interference for each beam in beam control using a plurality of antenna elements.

18. The wireless base station according to further comprising: claim 1, wherein
the at least one processor executes control of outputting information indicating a result of the interference analysis and information indicating a content of the wireless resource control that is to be executed or has been executed by the at least one processor.

19-20. (canceled)

21. A control device for a wireless base station comprising:
at least one memory configured to store instructions; and at least one processor configured to execute the instructions to
detect occurrence of interference in the wireless communication system,
execute interference analysis that is based on a result of detection by the interference detection means and includes estimation of consecutiveness of the interference, and
execute, according to a result of the interference analysis by the at least one processor, wireless resource control for reducing influence of the interference, wherein
the consecutiveness includes at least one of temporal consecutiveness and spatial consecutiveness.

22. A control method for a wireless base station comprising:
detecting, by at least one memory configured to store instructions; and at least one processor configured to execute the instructions to, occurrence of interference at the wireless base station;
executing, by the at least one processor, interference analysis that is based on a result of detection by the at least one processor and includes estimation of consecutiveness of the interference; and
executing, by the at least one processor, according to a result of analysis by the at least one processor, wireless resource control for reducing influence of the interference, wherein
the consecutiveness includes at least one of temporal consecutiveness and spatial consecutiveness.

23-25. (canceled)
